(19) United States
(12) Patent Application Publication
(10) Pub. No.: US 2025/0130391 A1
(43) Pub. Date: Apr. 24, 2025

(54) OPTICAL DEVICE

(71) Applicant: Sharp Sensing Technology Corporation, Tenri City (JP)

(72) Inventors: SAE MANO, Tenri City (JP); FUMIO TORIMATSU, Tenri City (JP); MASAHIRO NAKAMURA, Tenri City (JP); Haruno YOSHIDA, Tenri City (JP)

(21) Appl. No.: 18/918,288

(22) Filed: Oct. 17, 2024

(30) Foreign Application Priority Data
Oct. 20, 2023 (JP) 2023-181435

(51) Int. Cl. G02B 7/02; G02B 5/28; G03B 17/12; H04N 23/51

(52) U.S. Cl. CPC G02B 7/021; G02B 7/025; G03B 17/12; H04N 23/51; G02B 5/281

(57) ABSTRACT

An optical device includes a first lens group having an optical axis; a held body being either a second lens group or an image sensor; a first housing holding the first lens group and having: a first contact face that is perpendicular to the optical axis; and a first depression-defining face that is positioned adjacent to, and behind, the first contact face and that is positioned radially inward upon moving closer to the first contact face; a second housing holding the held body and having: a second contact face that is in contact with the first contact face; and a second depression-defining face that is positioned adjacent to, and behind, the second contact face and that, in combination with the first depression-defining face, defines a depression; and an adhesive provided in the depression and attaching the second housing to the first housing.

### CROSS-REFERENCE TO RELATED APPLICATION

The present application claims priority from Japanese Application JP 2023-181435, the content of which is hereby incorporated by reference into this application.

### BACKGROUND OF THE INVENTION

### Field of the Invention

The present disclosure relates to optical devices.

### Background of the Invention

Japanese Unexamined Patent Application Publication No. 2008-θ28838 discloses a camera module. This camera module includes a sensor base body and an optical system housing that are positioned relative to each other. The sensor base body and the optical system housing are attached to each other by an attaching member. The optical system housing has, at a front end thereof, a housing inclined portion that is inclined relative to the sensor base body. The attaching member is injected between the housing inclined portion and the sensor base body (paragraphs θ078 and θ080 and FIG. 1).

### SUMMARY OF THE INVENTION

In the camera module disclosed in Japanese Unexamined Patent Application Publication No. 2008-θ28838, the height and inclination of the optical system housing relative to the sensor base body are affected by the attaching member. Therefore, it is impossible to increase precision in the positioning of the optical system housing relative to the sensor base body.

In addition, the interface between the attaching member and the sensor base body has a small area in this camera module. Therefore, it is impossible to increase the strength of attachment of the optical system housing to the sensor base body.

The present disclosure, in one aspect thereof, has been made in view of these problems. The present disclosure, in one aspect thereof, has an object to provide, for example, an optical device that enables increasing precision in the positioning of a first housing relative to a second housing and that enables increasing the strength of adhesion between the first housing and the second housing.

### Solution to the Problems

The present disclosure, in one aspect thereof, is directed to an optical device including: a first lens group having an optical axis; a held body being either a second lens group or an image sensor; a first housing holding the first lens group and having: a first contact face that is perpendicular to the optical axis; and a first depression-defining face that is positioned adjacent to, and behind, the first contact face and that is positioned radially inward upon moving closer to the first contact face; a second housing holding the held body and having: a second contact face that is in contact with the first contact face; and a second depression-defining face that is positioned adjacent to, and behind, the second contact face and that, in combination with the first depression-defining face, defines a depression; and an adhesive provided in the depression and attaching the second housing to the first housing.

### BRIEF DESCRIPTION OF THE DRAWINGS

FIG. 1 is a schematic perspective view of a camera module in accordance with Embodiment 1.

FIG. 2 is a schematic cross-sectional view of the camera module in accordance with Embodiment 1.

FIG. 3 is a schematic cross-sectional view of a part of the camera module in accordance with Embodiment 1.

FIG. 4 is a schematic perspective view of a front-side lens housing in the camera module in accordance with Embodiment 1.

FIG. 5 is a schematic perspective view of a rear-side lens housing in the camera module in accordance with Embodiment 1.

FIG. 6 is a schematic cross-sectional view of a front-side lens group, a front-side lens housing, and a rear-side lens housing in the camera module in accordance with Embodiment 1 before the front-side lens housing and the rear-side lens housing are attached to each other.

FIG. 7 is a schematic cross-sectional view of a lens unit and an optical axis adjusting unit both in the camera module in accordance with Embodiment 1, the optical axis adjusting unit being used to adjust the optical axis of the lens unit.

FIG. 8 is a schematic perspective view of a camera module in accordance with Embodiment 2.

FIG. 9 is a schematic cross-sectional view of the camera module in accordance with Embodiment 2.

FIG. 10 is a schematic cross-sectional view of a part of the camera module in accordance with Embodiment 2.

FIG. 11 is a schematic perspective view of a lens housing in the camera module in accordance with Embodiment 2.

FIG. 12 is a schematic perspective view of a housing in the camera module in accordance with Embodiment 2.

FIG. 13 is a schematic cross-sectional view of the camera module in accordance with Embodiment 2 and an optical axis adjusting unit used to adjust the optical axis of this camera module.

FIG. 14 is a schematic perspective view of a camera module in accordance with Embodiment 3.

FIG. 15 is a schematic cross-sectional view of the camera module in accordance with Embodiment 3.

FIG. 16 is a schematic cross-sectional view of a part of the camera module in accordance with Embodiment 3.

FIG. 17 is a schematic perspective view of a front-side lens housing in the camera module in accordance with Embodiment 3.

FIG. 18 is a schematic perspective view of a rear-side lens housing in the camera module in accordance with Embodiment 3.

FIG. 19 is a schematic perspective view of a camera module in accordance with Embodiment 4.

FIG. 20 is a schematic perspective view of a lens housing in the camera module in accordance with Embodiment 4.

FIG. 21 is a schematic perspective view of a housing in the camera module in accordance with Embodiment 4.

FIG. 22 is a schematic perspective view of a lens housing in the camera module in accordance with Embodiment 5.

FIG. 23 is a schematic perspective view of a part of the lens housing in the camera module in accordance with Embodiment 5.

FIG. 24 is a schematic cross-sectional view of a front-side lens group and a part of the lens housing in the camera module in accordance with Embodiment 5.

FIG. 25 is a schematic top view of a camera module in accordance with Embodiment 6.

FIG. 26 is a schematic cross-sectional view of the camera module in accordance with Embodiment 6.

FIG. 27 is a schematic cross-sectional view of the camera module in accordance with Embodiment 6.

FIG. 28 is a schematic cross-sectional view of a part of the camera module in accordance with Embodiment 6.

FIG. 29 is a schematic cross-sectional view of a part of the camera module in accordance with Embodiment 6.

FIG. 30 is a schematic perspective view of a rear-side lens housing in the camera module in accordance with Embodiment 6.

FIG. 31 is a schematic cross-sectional view of a camera module in accordance with Embodiment 7.

FIG. 32 is a schematic cross-sectional view of a part of the camera module in accordance with Embodiment 7.

FIG. 33 is a schematic cross-sectional view of a camera module in accordance with Embodiment 8.

FIG. 34 is a schematic cross-sectional view of a part of the camera module in accordance with Embodiment 8.

### DETAILED DESCRIPTION OF THE INVENTION

The following will describe embodiments of the present disclosure with reference to drawings. Note that identical and equivalent elements in the drawings are denoted by the same reference numerals, and description thereof is not repeated.

### 1 Embodiment 1

### 1.1 Camera Module

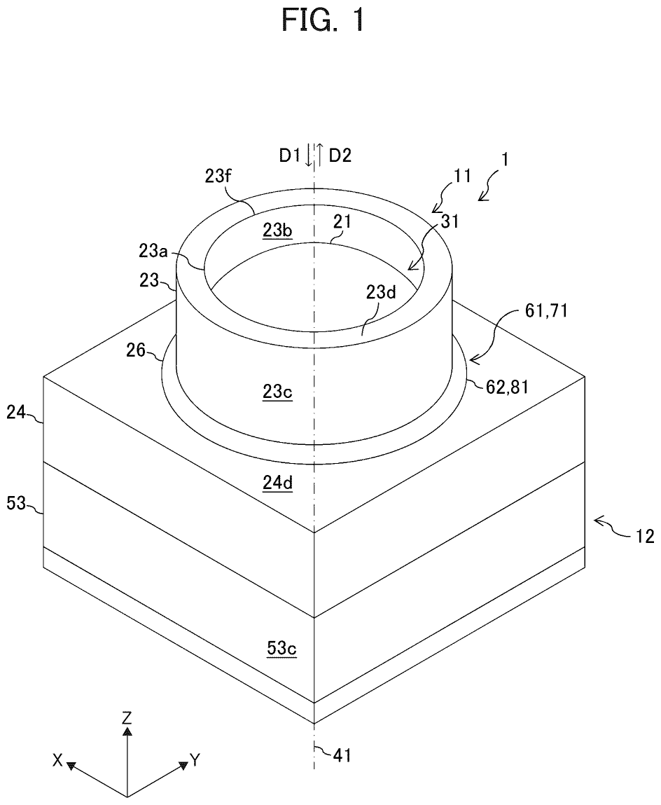

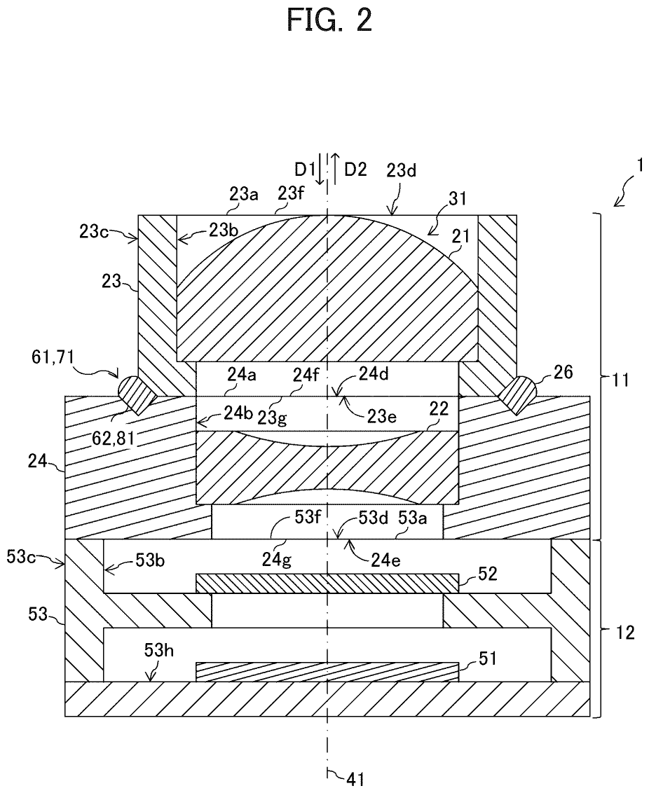

FIG. 1 is a schematic perspective view of a camera module in accordance with Embodiment 1. FIG. 2 is a schematic cross-sectional view of the camera module in accordance with Embodiment 1.

A camera module 1 in accordance with Embodiment 1 shown in FIGS. 1 and 2 forms an image of an object, captures the formed image of the object, and outputs an image signal in accordance with the image of the object. The camera module 1 is incorporated into a smartphone. The camera module 1 may be incorporated into a mobile communications terminal other than a smartphone. The camera module 1 may be incorporated into an apparatus other than a mobile communications terminal.

Referring to FIGS. 1 and 2, the camera module 1 includes a lens unit 11 and an image capturing unit 12.

The lens unit 11 forms an image of an object.

The image capturing unit 12 is disposed on the rear side of the lens unit 11. The image capturing unit 12 captures the formed image of the object and outputs an image signal in accordance with the image of the object.

### 1.2 Lens Unit

Referring to FIGS. 1 and 2, the lens unit 11 includes a lens group 21, a lens group 22, a lens housing 23, a lens housing 24, and an adhesive 26.

The lens group 21 and the lens group 22 provide an optical system 31. The optical system 31 transmits object light that comes from an object and converges the transmitted object light on an image capturing face. The optical system 31 hence forms an image of the object on the image capturing face. The optical system 31 has an optical axis 41. The optical system 31 may be replaced by an optical system other than the optical system provided by the lens group 21 and the lens group 22.

The lens group 21 includes one or more lenses. The lens group 21, as a whole, has a positive power. The lens group 21 receives object light and guides the received object light to the lens group 22. The lens group 21 has an optical axis that coincides with the optical axis 41 of the optical system 31.

The lens group 22 includes one or more lenses. The lens group 22, as a whole, has a negative power. The lens group 22 is disposed on the rear side of the lens group 21. The lens group 22 converges the guided object light on the image capturing face. The lens group 22 has an optical axis that coincides with the optical axis 41 of the optical system 31.

The lens housing 23 has a cylindrical shape. The lens housing 23 has a hole 23a formed therein. The hole 23a accommodates the lens group 21. The lens housing 23 has an inner circumferential face 23b, an outer circumferential face 23c, a front face 23d, and a rear face 23e. The hole 23a is defined by the inner circumferential face 23b. The hole 23a has a front opening 23f and a rear opening 23g. The front opening 23f and the rear opening 23g are provided on the front face 23d and on the rear face 23e respectively. The lens housing 23 holds the lens group 21. The lens housing 23 is alternatively referred to as, for example, a lens barrel.

The lens housing 24 is shaped like a holed rectangular parallelepiped. Therefore, the lens housing 24 has a hole 24a formed therein. The hole 24a accommodates the lens group 22. The lens housing 24 has an inner circumferential face 24b, a front face 24d, and a rear face 24e. The hole 24a is defined by the inner circumferential face 24b. The hole 24a has a front opening 24f and a rear opening 24g. The front opening 24f and the rear opening 24g are provided on the front face 24d and on the rear face 24e respectively. The front opening 24f overlaps the rear opening 23g of the lens housing 23. Hence, the hole 24a is spatially continuous with the hole 23a. The lens housing 24 holds the lens group 22. The lens housing 24 is alternatively referred to as, for example, a lens barrel.

The lens housing 24 has a shape that is larger than the shape of the lens housing 23 when viewed in a plan view from the Z-direction which is parallel to the optical axis 41. Therefore, the center of the front face 24d of the lens housing 24 is located opposite either the rear face 23e of the lens housing 23 or the rear opening 23g on the rear face 23e. The periphery of the front face 24d of the lens housing 24 is not located opposite the rear face 23e of the lens housing 23.

The adhesive 26 is provided contiguously and both on the outer circumferential face 23c of the lens housing 23 and on the front face 24d of the lens housing 24. Hence, the adhesive 26 attaches the lens housing 23 and the lens housing 24 to each other.

The adhesive 26 is a cured product of a combination type of adhesive that is cured by both ultraviolet light and heat. Therefore, when the adhesive 26 is provided contiguously and both on the outer circumferential face 23c of the lens housing 23 and on the front face 24d of the lens housing 24, a viscosity fluid that is a precursor to the adhesive 26 is applied contiguously and both on the outer circumferential face 23c and on the front face 24d. The applied viscosity fluid is cured under ultraviolet light. A cured product is hence obtained. The obtained cured product is heated for further curing. The cured product hence exhibits increased strength. The adhesive 26 is hence obtained. The adhesive 26 may be a cured product of a combination type of adhesive that is cured by both ultraviolet light and, for example, water content or a curing accelerator.

When the adhesive 26 is obtained from a viscosity fluid, changes in the crosslink density and curing shrinkage such as volume shrinkage can occur in chemical reactions. The obtained adhesive 26 has residual stress. The obtained adhesive 26 generates outgas.

When an uncured portion, not illuminated by ultraviolet light and hence not cured, remains after the viscosity fluid is placed under ultraviolet light, the curing shrinkage increases, and more outgas is generated, in comparison with when no uncured portion remains.

In the camera module 1, the lens unit 11 provides an optical device including a first housing and a second housing that are attached to each other by the adhesive 26. In addition, the lens housing 23 and the lens housing 24 respectively provide the first housing and the second housing that are attached to each other by the adhesive 26. In addition, the lens group 21 and the lens group 22 provide a held body that is held by the first housing and the second housing respectively. In addition, the lens group 21 and the lens group 22 provide a first lens group and a second lens group that are held by the first housing and the second housing respectively.

### 1.3 Image Capturing Unit

Referring to FIGS. 1 and 2, the image capturing unit 12 includes an image sensor 51, an infrared light cut filter 52, and a housing 53.

The image sensor 51 is disposed on the rear side of the optical system 31. The image sensor 51 receives the object light converged on the image capturing face and photoelectrically converts the received object light to an electric signal. Hence, the image sensor 51 captures an object image formed on the image capturing face and outputs an image signal in accordance with the object image. The image sensor 51 is, for example, a complementary metal-oxide semiconductor (CMOS) image sensor or a charge coupled device (CCD) image sensor.

The infrared light cut filter 52 is disposed on the rear side of the optical system 31 (on the front side of the image sensor 51). The infrared light cut filter 52 transmits the object light converged on the image capturing face and removes infrared light from the object light to be transmitted.

The housing 53 is shaped like a holed rectangular parallelepiped. The housing 53 has a hole 53a formed therein. The housing 53 has an inner circumferential face 53b, an outer circumferential face 53c, a front face 53d, and an inner bottom face 53h. The hole 53a is defined by the inner circumferential face 53b and the inner bottom face 53h. The hole 53a has a front opening 53f. The front opening 53f is provided on the front face 53d. The front opening 53f overlaps the rear opening 24g of the lens housing 24. Hence, the hole 53a is spatially continuous with the hole 24a in the lens housing 24.

### 1.4 Positioning Lens Housing

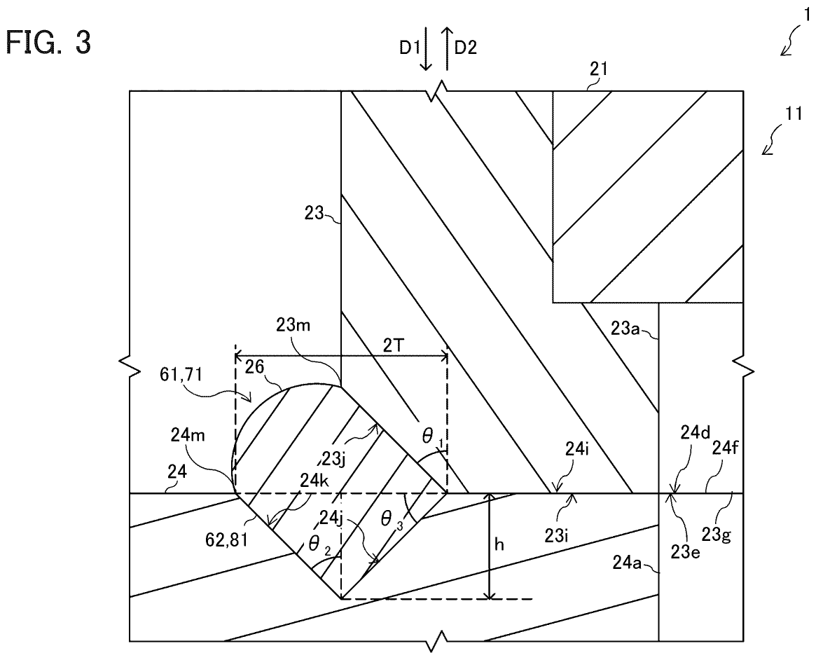

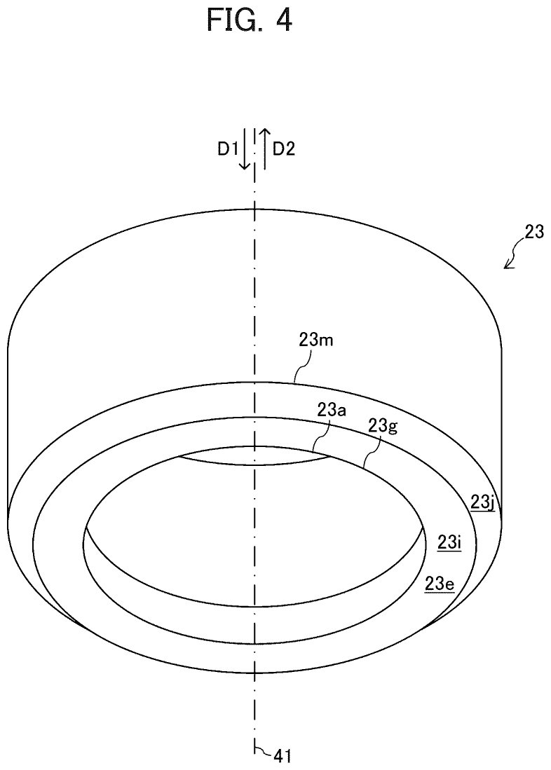

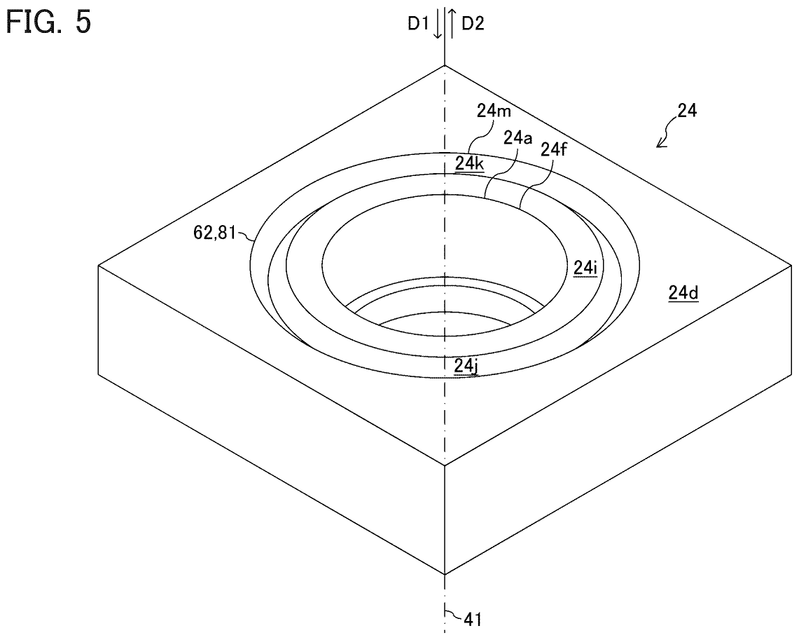

FIG. 3 is a schematic cross-sectional view of a part of the camera module in accordance with Embodiment 1. FIG. 4 is a schematic perspective view of a front-side lens housing in the camera module in accordance with Embodiment 1. FIG. 5 is a schematic perspective view of a rear-side lens housing in the camera module in accordance with Embodiment 1.

Referring to FIGS. 3 and 4, the lens housing 23 has a contact face 23i. The contact face 23i is a part of the rear face 23e of the lens housing 23. The contact face 23i is perpendicular to the optical axis 41. The contact face 23i is oriented in a first direction D1 that points toward the rear side.

Referring to FIGS. 3 and 5, the lens housing 24 has a contact face 24i. The contact face 24i is a part of the front face 24d of the lens housing 24. The contact face 24i is perpendicular to the optical axis 41. The contact face 24i is oriented in a second direction D2 that points toward the front side. The second direction D2 is opposite to the first direction D1.

The contact face 23i of the lens housing 23 and the contact face 24i of the lens housing 24 are in contact with each other. No adhesive 26 is interposed between the contact face 23i and the contact face 24i. Hence, the position of the lens housing 23 can be determined relative to the lens housing 24 in the Z-direction which is parallel to the optical axis 41, which enables eliminating the inclination of the lens housing 23 relative to the lens housing 24.

When the lens housing 23 and the lens housing 24 are not in contact with each other, and the adhesive 26 is interposed between the lens housing 23 and the lens housing 24, as in the camera module disclosed in Japanese Unexamined Patent Application Publication No. 2008-θ28838, the position and inclination of the lens housing 23 relative to the lens housing 24 are affected by the quantity of the adhesive 26, the curing shrinkage that can occur in obtaining the adhesive 26, and the residual stress generated in the adhesive 26. Therefore, it is difficult to achieve a desirable state of these position and inclination. In addition, these position and inclination will show increased differences from one article to the other.

In contrast, when the lens housing 23 and the lens housing 24 are in contact with each other as in the camera module 1 in accordance with Embodiment 1, the position and inclination of the lens housing 23 relative to the lens housing 24 are not affected by the quantity of the adhesive 26, the curing shrinkage that can occur in obtaining the adhesive 26, and the residual stress generated in the adhesive 26. Therefore, it is easy to achieve a desirable state of these position and inclination. In addition, these position and inclination will show reduced differences from one article to the other.

The contact face 23i of the lens housing 23 is provided all along the outer circumference of the rear opening 23g of the lens housing 23. The contact face 24i of the lens housing 24 is provided all along the outer circumference of the front opening 24f of the lens housing 24. Therefore, the contact face 23i and the contact face 24i are shaped like a ring that makes a complete round in the circumferential direction with the center being located on the optical axis 41. Therefore, the contact face 23i and the contact face 24i are in contact with each other all along the entire circumference in the circumferential direction. Hence, it is possible to restrain a gap from forming between the lens housing 23 and the lens housing 24. Hence, it is possible to restrain the viscosity fluid from flowing from a gap between the lens housing 23 and the lens housing 24 to the hole 23a in the lens housing 23 and the hole 24a in the lens housing 24.

In the camera module 1, the contact face 23i of the lens housing 23 and the contact face 24i of the lens housing 24 respectively provide a first contact face and a second contact face that are in contact with each other.

### 1.5 Attaching Lens Housing

Referring to FIGS. 2 and 3, the lens housing 23 and the lens housing 24 have a depression 61 formed therein.

The depression 61 is formed contiguously and both in both the lens housing 23 and in the lens housing 24.

The depression 61 is shaped like a ring that makes a complete round in the circumferential direction with the center being located on the optical axis 41 when viewed in a plan view from the Z-direction which is parallel to the optical axis 41. Therefore, the depression 61 is built around a groove 71 that is shaped like a ring. When viewed in a cross-sectional view taken along a plane containing the optical axis 41, the depression 61 has two cross-sections each having a square cross-sectional shape and has a cross-sectional shape that is symmetric with respect to the optical axis 41.

The adhesive 26 is provided in the depression 61.

The adhesive 26 generally has a shape that fits to the shape of the depression 61. Therefore, the adhesive 26 is shaped like a ring that makes a complete round in the circumferential direction with the center being located on the optical axis 41. When viewed in a cross-sectional view taken along a plane containing the optical axis 41, the adhesive 26 has two cross-sections each having a square cross-sectional shape and has a cross-sectional shape that is symmetric with respect to the optical axis 41.

Hence, it becomes possible to apply the same quantity of viscosity fluid to the locations that are symmetric with respect to the optical axis 41. Hence, it becomes possible to generate the same magnitude of stress in the cross-sectional direction in these locations in curing the viscosity fluid. Hence, it becomes possible to restrain the deviation in position of the lens housing 23 relative to the lens housing 24 in the X- and Y-directions which are perpendicular to the optical axis 41.

When the adhesive 26 is provided in the depression 61, which is formed contiguously and both in the lens housing 23 and in the lens housing 24, it is possible to increase the adhesive 26 that attaches the lens housing 23 and the lens housing 24 to each other in comparison with when an adhesive is provided in, for example, a depression or a notch that is formed only in either one of the lens housing 23 and the lens housing 24. Hence, the adhesive 26 can firmly attach the lens housing 23 and the lens housing 24 to each other.

When the adhesive 26 is provided in the depression 61, which is shaped like a ring, the adhesive 26 can attach the lens housing 23 and the lens housing 24 to each other all along the entire circumference in the circumferential direction. Hence, the adhesive 26 can firmly attach the lens housing 23 and the lens housing 24 to each other.

The adhesive 26 is obtained by applying a viscosity fluid in the depression 61, illuminating the applied viscosity fluid with ultraviolet light to cause the applied viscosity fluid to change into a cured product, and heating the cured product to cause the cured product to change into a cured product that has an even greater strength.

The depression 61 can retain the viscosity fluid by surface tension. Therefore, when the adhesive 26 is obtained from a viscosity fluid applied inside the depression 61, the viscosity fluid can be restrained from flowing and spreading in comparison with when the adhesive 26 is obtained from a viscosity fluid applied onto a flat surface.

### 1.6 Depression-Defining Face

Referring to FIGS. 3 and 4, the lens housing 23 has a depression-defining face 23j.

The depression-defining face 23j of the lens housing 23 is shaped like a ring that makes a complete round in the circumferential direction with the center being located on the optical axis 41 when viewed in a plan view from the Z-direction which is parallel to the optical axis 41. The depression-defining face 23j is adjacent to the contact face 23i of the lens housing 23. The depression-defining face 23j is positioned radially outside the contact face 23i and behind the contact face 23i. The depression-defining face 23j being positioned behind the contact face 23i indicates that the depression-defining face 23j is positioned further down in the second direction D2 than is the contact face 23i. The depression-defining face 23j is oriented in a first inclined direction that is inclined radially outward from the first direction D1. Therefore, the depression-defining face 23j is positioned radially inward upon moving closer to the contact face 23i. Hence, the depression-defining face 23j imparts a taper shape and a notch shape to the rear end portion of the lens housing 23.

Referring to FIGS. 3 and 5, the lens housing 24 has a depression-defining face 24j and a depression-defining face 24k.

The depression-defining face 24j of the lens housing 24 is shaped like a ring that makes a complete round in the circumferential direction with the center being located on the optical axis 41 when viewed in a plan view from the Z-direction which is parallel to the optical axis 41. The depression-defining face 24j is a part of the front face 24d of the lens housing 24. The depression-defining face 24j is adjacent to the contact face 24i of the lens housing 24. The depression-defining face 24j is positioned radially outside the contact face 24i and behind the contact face 24i. The depression-defining face 24j being positioned behind the contact face 24i indicates that the depression-defining face 24j is positioned further down in the first direction D1 than is the contact face 24i. The depression-defining face 24j is oriented in a second inclined direction that is inclined radially outward from the second direction D2. Therefore, the depression-defining face 24j is positioned radially inward upon moving closer to the contact face 24i.

The depression-defining face 24k of the lens housing 24 is shaped like a ring that makes a complete round in the circumferential direction with the center being located on the optical axis 41 when viewed in a plan view from the Z-direction which is parallel to the optical axis 41. The depression-defining face 24k is a part of the front face 24d of the lens housing 24. The depression-defining face 24k is adjacent to the depression-defining face 24j of the lens housing 24. The depression-defining face 24k is positioned radially outside the depression-defining face 24j and behind the contact face 24i. The depression-defining face 24k being positioned behind the contact face 24i indicates that the depression-defining face 24k is positioned further down in the first direction D1 than is the contact face 24i.

The depression-defining face 23j of the lens housing 23 and the depression-defining face 24k of the lens housing 24 are generally parallel to each other and provide the inner side face of the depression 61. The depression-defining face 24j of the lens housing 24 is generally perpendicular to the depression-defining face 23j and the depression-defining face 24k and provides the inner bottom face of the depression 61. Hence, the depression 61 has two cross-sections each having a square cross-sectional shape when viewed in a cross-sectional view taken along a plane containing the optical axis 41. Hence, in the plane containing the optical axis 41, the entire interior of the depression 61 is visible from a direction that is parallel to the depression-defining face 23j and the depression-defining face 24k. Hence, the entire viscosity fluid applied to the interior of the depression 61 can be uniformly illuminated by ultraviolet light from this direction. Hence, the entire viscosity fluid can be uniformly cured. Hence, it is possible to reduce remaining uncured portions. Hence, the curing shrinkage can be restrained from increasing. In addition, the generation of outgas can be reduced.

The angle θ1 between the depression-defining face 23j of the lens housing 23 and the optical axis 41 and the angle θ2 between the depression-defining face 24k of the lens housing 24 and the optical axis 41 preferably satisfy conditions: θ1≤θ2 and θ1=approximately 45°. When the angle θ1 and the angle θ2 satisfy these conditions, the depression 61 does not narrow down toward the opening so that the optical path of ultraviolet light moves away from the lens housing 23 and the lens housing 24. Hence, the viscosity fluid applied to the interior of the depression 61 can be efficiently illuminated with ultraviolet light.

The ultraviolet light projector for illuminating the viscosity fluid applied to the interior of the depression 61 with ultraviolet light has a spot diameter that is preferably specified larger than the distance from a front edge 23m of the depression-defining face 23j of the lens housing 23 to a radially outer edge 24m of the depression-defining face 24k of the lens housing 24. Hence, in the plane containing the optical axis 41, the entire viscosity fluid can be illuminated with ultraviolet light without having to move the optical path of the ultraviolet light. Hence, the viscosity fluid can be efficiently illuminated with ultraviolet light.

The depression-defining face 24j of the lens housing 24 is oriented in an inclined direction that is inclined radially outward from the second direction D2. The depression-defining face 24k of the lens housing 24 is oriented in another inclined direction that is inclined radially inward from the second direction D2. Hence, the depression-defining face 24j and the depression-defining face 24k define a depression 62. The depression 62 is formed in the lens housing 24 and is a part of the depression 61. The depression 62 is shaped like a ring that makes a complete round in the circumferential direction with the center being located on the optical axis 41 when viewed in a plan view from the Z-direction which is parallel to the optical axis 41. Therefore, the depression 62 is built around a groove 81 that is shaped like a ring. When viewed in a cross-sectional view taken along a plane containing the optical axis 41, the depression 62 has two cross-sections each having a V-shaped cross-sectional shape.

A part of the adhesive 26 has a wedge-like shape and enters the depression 62 of the lens housing 24. The depression-defining face 24j and the depression-defining face 24k of the lens housing 24 that define the depression 62 obstructs the part of the adhesive 26 that has entered the depression 62 from moving radially. Hence, the adhesive 26 can be restrained from moving in the shear direction in comparison with when the adhesive 26 is provided on a flat surface. Hence, the lens housing 23 and the lens housing 24 are more firmly attached.

The depression-defining face 23j of the lens housing 23, the depression-defining face 24j of the lens housing 24, and the depression-defining face 24k of the lens housing 24 provide a first depression-defining face, a second depression-defining face, and a third depression-defining face that define the depression 61 which is a first depression. The depression-defining face 24j and the depression-defining face 24k provide the second depression-defining face and the third depression-defining face that define the depression 62 which is a second depression.

### 1.7 Retaining Viscosity Fluid Before Attaching

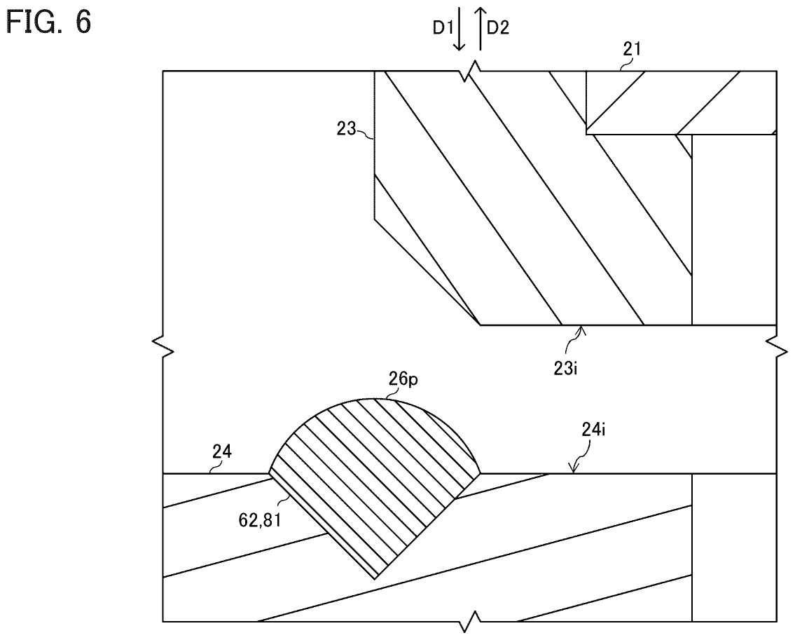

FIG. 6 is a schematic cross-sectional view of a front-side lens group, a front-side lens housing, and a rear-side lens housing in the camera module in accordance with Embodiment 1 before the front-side lens housing and the rear-side lens housing are attached to each other.

Referring to FIG. 6, the depression 62 of the lens housing 24 is provided before the lens housing 23 and the lens housing 24 are attached to each other. Therefore, the depression 62 can retain a viscosity fluid 26p by surface tension even before the lens housing 23 and the lens housing 24 are attached to each other.

Therefore, the viscosity fluid 26p is applied to the interior of the depression 62 of the lens housing 24 before the lens housing 23 and the lens housing 24 are attached to each other. Subsequently, the lens housing 23 is placed on the lens housing 24. Hence, the contact face 23i of the lens housing 23 and the contact face 24i of the lens housing 24 come in contact with each other. In addition, the viscosity fluid 26p spreads inside the depression 61. Subsequently, the viscosity fluid 26p that has spread inside the depression 61 is cured.

### 1.8 Adjusting Optical Axis

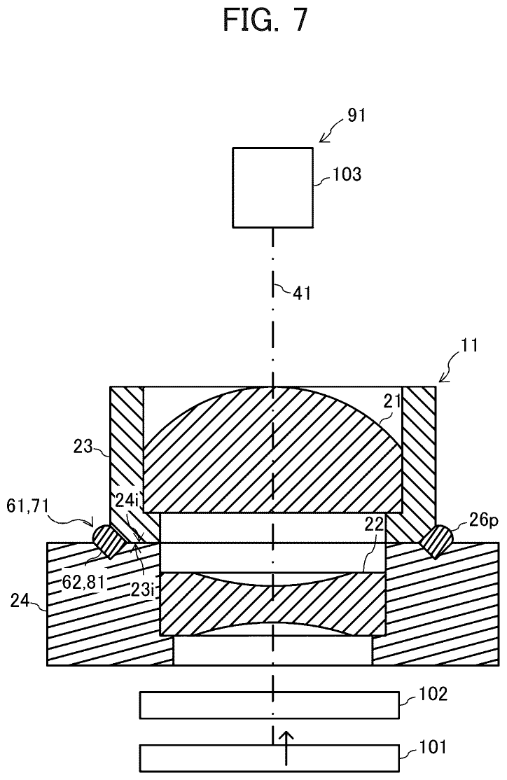

FIG. 7 is a schematic cross-sectional view of a lens unit and an optical axis adjusting unit both in the camera module in accordance with Embodiment 1, the optical axis adjusting unit being used to adjust the optical axis of the lens unit.

Referring to FIG. 7, an optical axis adjusting unit 91 used to adjust the optical axis of the lens unit 11 includes a light source 101, a reticle 102, and an image capturing section 103.

The light source 101 emits light.

The reticle 102 transmits the light emitted by the light source 101.

The lens group 22 transmits the light transmitted by the reticle 102.

The lens group 21 transmits the light transmitted by the lens group 22.

The image capturing section 103 receives the light transmitted by the lens group 21.

Hence, the pattern of the reticle 102 is projected onto the image capturing section 103. Hence, the resolution of the optical system 31 can be measured at the center and along the periphery.

When the optical axis 41 is adjusted using the optical axis adjusting unit 91, the lens housing 23 is moved relative to the lens housing 24 in the X- and Y-directions, which are perpendicular to the optical axis 41, while the resolution of the optical system 31 is being measured. In addition, the position of the lens housing 23 relative to the lens housing 24 at which the resolution of the optical system 31 is optimized is determined with respect to the X- and Y-directions. In addition, the viscosity fluid 26p is cured to fix the lens housing 23 and the lens housing 24 relative to each other while maintaining the lens housing 23 relative to the lens housing 24 at the position where the resolution of the optical system 31 is optimized. Hence, the optical axis of the lens group 21 and the optical axis of the lens group 22 can be aligned to each other. Hence, it is possible to provide the lens unit 11 that exhibits high performance.

To move the lens housing 23 relative to the lens housing 24 in the X- and Y-directions which are perpendicular to the optical axis 41, the lens housing 23 needs to be moved relative to the lens housing 24 in the X- and Y-directions while maintaining the contact face 23i of the lens housing 23 and the contact face 24i of the lens housing 24 in contact with each other. Therefore, the contact face 23i and the contact face 24i are subjected to surface treatment such as mirror polishing or coating. Hence, the contact face 23i and the contact face 24i have such a sliding property that one of the contact face 23i and the contact face 24i can be slid relative to the other one of the contact face 23i and the contact face 24i.

When the lens housing 23 is moved relative to the lens housing 24 in the X- and Y-directions, which are parallel to the optical axis 41 and perpendicular to the optical axis 41, the viscosity fluid 26p could flow radially outward due to the movement of the lens housing 23. However, when the depression 62 is formed in the lens housing 24, the viscosity fluid 26p can be restrained from flowing radially outward in comparison with when the depression 62 is not formed in the lens housing 24. Hence, it becomes easier to control the quantity of the viscosity fluid 26p.

### 1.9 Adhesion Area

When a part of the adhesive 26 enters the depression 62 of the lens housing 24, the adhesion area Sa16, which is the area of the interface between the lens housing 24 and the adhesive 26, is given by equation (1),

$$Sa 16 = 2 T \cdot Ls / cos θ3 \qquad ( 1 )$$

where 2T is the radial dimension of the depression 62, Ls is the length of the circumference formed by the deepest part of the depression 62 where the depression 62 has a maximum depth h, and θ3 is the angle of inclination of the depression-defining face 24j and the depression-defining face 24k of the lens housing 24.

Meanwhile, when the adhesive 26 is provided on a flat surface, the adhesion area Sa16 is given by equation (2).

$$Sa 16 = 2 T \cdot Ls \qquad ( 2 )$$

Since 0<cos θ3<1, the relationship, 2T·Ls<2T·Ls/cos θ3, holds. This relationship indicates that the adhesion area Sa16 is larger when a part of the adhesive 26 enters the depression 62 of the lens housing 24 than when the adhesive 26 is provided on a flat surface.

### 2 Embodiment 2

The following will describe differences of Embodiment 2 to Embodiment 1. The description may be silent about the structures and features of Embodiment 2 that are the same as those of Embodiment 1.

### 2.1 Camera Module

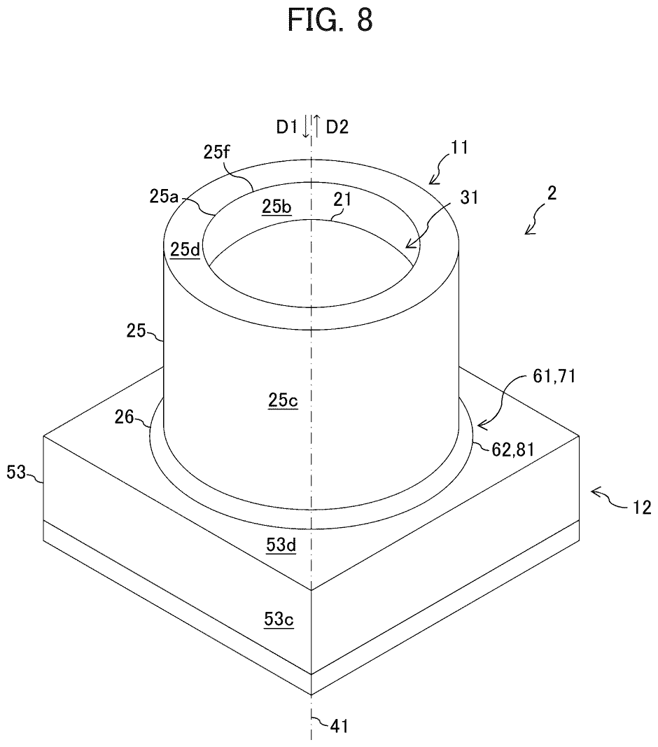

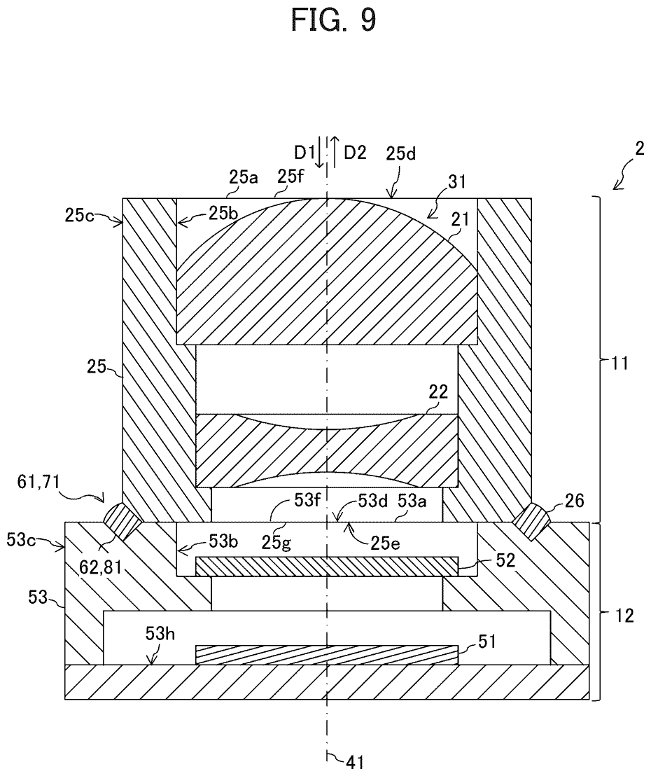

FIG. 8 is a schematic perspective view of a camera module in accordance with Embodiment 2. FIG. 9 is a schematic cross-sectional view of the camera module in accordance with Embodiment 2.

Referring to FIGS. 8 and 9, a camera module 2 in accordance with Embodiment 2 includes a lens unit 11, an image capturing unit 12, and an adhesive 26.

The adhesive 26 attaches the lens unit 11 and the image capturing unit 12 to each other.

Referring to FIGS. 8 and 9, the lens unit 11 includes a lens group 21, a lens group 22, and a lens housing 25.

The lens housing 25 has a cylindrical shape. Therefore, the lens housing 25 has a hole 25a formed therein. The hole 25a accommodates the lens group 21 and the lens group 22. The lens housing 25 has an inner circumferential face 25b, an outer circumferential face 25c, a front face 25d, and a rear face 25e. The hole 25a is defined by the inner circumferential face 25b. The hole 25a has a front opening 25f and a rear opening 25g. The front opening 25f and the rear opening 25g are provided on the front face 25d and on the rear face 25e respectively. The lens housing 25 holds the lens group 21 and the lens group 22. The lens housing 25 is alternatively referred to as, for example, a lens barrel.

The front opening 53f of the housing 53 overlaps the rear opening 25g of the lens housing 25. Hence, the hole 53a in the housing 53 is spatially continuous with the hole 25a in the lens housing 25.

The housing 53 has a shape that is larger than the shape of the lens housing 25 when viewed in a plan view from the Z-direction which is parallel to the optical axis 41. Therefore, the center of the front face 53d of the housing 53 is located opposite either the rear face 25e of the lens housing 25 or the rear opening 25g on the rear face 25e. The periphery of the front face 53d of the housing 53 is not located opposite the rear face 25e of the lens housing 25.

The adhesive 26 is provided contiguously and both on the outer circumferential face 25c of the lens housing 25 and on the front face 53d of the housing 53. Hence, the adhesive 26 attaches the lens housing 25 and the housing 53 to each other.

The camera module 2 provides an optical device including a first housing and a second housing that are attached to each other by the adhesive 26. In addition, the lens housing 25 and the housing 53 respectively provide the first housing and the second housing that are attached to each other by the adhesive 26. In addition, the lens group 21 and the lens group 22 provide a held body that is held by the first housing, and the image sensor 51 provides a held body that is held by the second housing. In addition, the lens group 21 and the lens group 22 provide a first lens group that is held by the first housing. In addition, the lens group 21 and the lens group 22 provide a held body that is held by the first housing, and the image sensor 51 provides a held body that is held by the second housing.

### 2.2 Positioning Lens Housing

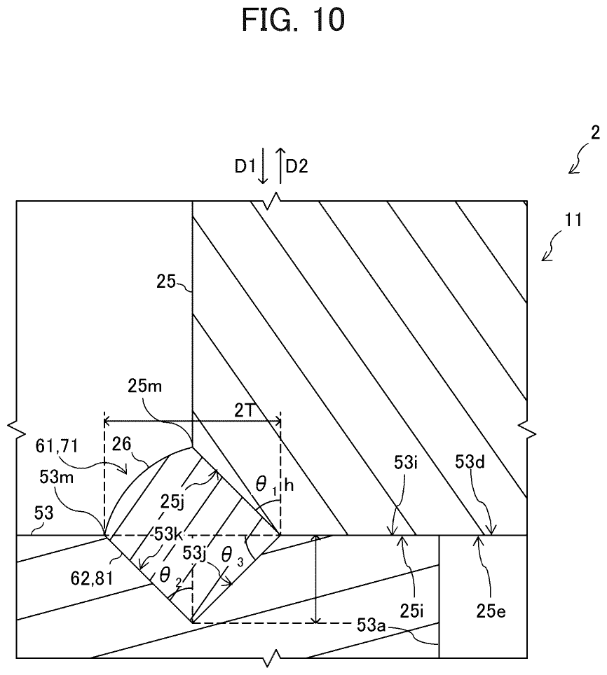

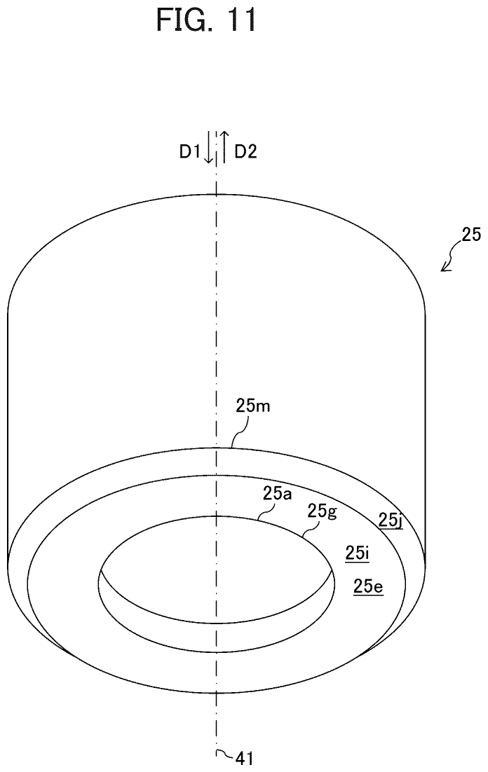

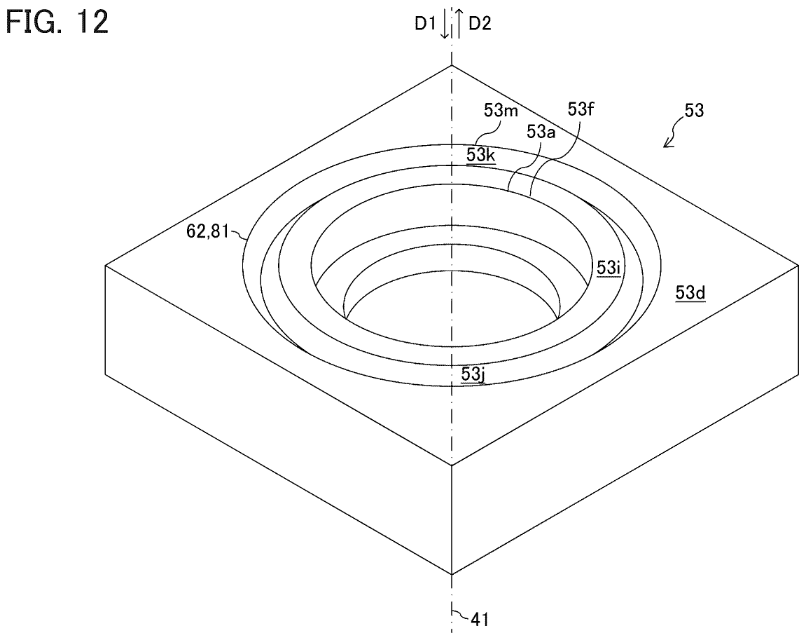

FIG. 10 is a schematic cross-sectional view of a part of the camera module in accordance with Embodiment 2. FIG. 11 is a schematic perspective view of a lens housing in the camera module in accordance with Embodiment 2. FIG. 12 is a schematic perspective view of a housing in the camera module in accordance with Embodiment 2.

Referring to FIGS. 10 and 11, the lens housing 25 has a contact face 25i. The contact face 25i is a part of the rear face 25e of the lens housing 25. The contact face 25i is perpendicular to the optical axis 41. The contact face 25i is oriented in a first direction D1 that points toward the rear side.

Referring to FIGS. 10 and 12, the housing 53 has a contact face 53i. The contact face 53i is a part of the front face 53d of the housing 53. The contact face 53i is perpendicular to the optical axis 41. The contact face 53i is oriented in a second direction D2 that points toward the rear side. The second direction D2 is opposite to the first direction D1.

The contact face 25i of the lens housing 25 and the contact face 53i of the housing 53 are in contact with each other. No adhesive 26 is interposed between the contact face 25i and the contact face 53i. Hence, the position of the lens housing 25 can be determined relative to the housing 53 in the Z-direction which is parallel to the optical axis 41, which enables eliminating the inclination of the lens housing 25 relative to the housing 53.

When the lens housing 25 and the housing 53 are in contact with each other, the position and inclination of the lens housing 25 relative to the housing 53 are not affected by the quantity of the adhesive 26, the curing shrinkage that can occur in obtaining the adhesive 26, and the residual stress generated in the adhesive 26. Therefore, it is easy to achieve a desirable state of these position and inclination. In addition, these position and inclination will show reduced differences from one article to the other.

The contact face 25i of the lens housing 25 and the contact face 53i of the housing 53 are shaped like a ring that makes a complete round in the circumferential direction with the center being located on the optical axis 41. Therefore, the contact face 25i and the contact face 53i are in contact with each other all along the entire circumference in the circumferential direction. Hence, it is possible to restrain a gap from forming between the lens housing 25 and the housing 53. Hence, it is possible to restrain the viscosity fluid from flowing from a gap between the lens housing 25 and the housing 53 to the hole 25a in the lens housing 25 and the hole 53a in the housing 53.

In the camera module 2, the contact face 25i of the lens housing 25 and the contact face 53i of the housing 53 respectively provide a first contact face and a second contact face that are in contact with each other.

### 2.3 Attaching Lens Housing and Housing

Referring to FIGS. 9 and 10, the lens housing 25 and the housing 53 have a depression 61 formed therein.

The depression 61 is formed contiguously and both in the lens housing 25 in the housing 53.

The depression 61 is shaped like a ring that makes a complete round in the circumferential direction with the center being located on the optical axis 41 when viewed in a plan view from the Z-direction which is parallel to the optical axis 41. Therefore, the depression 61 is built around a groove 71 that is shaped like a ring. When viewed in a cross-sectional view taken along a plane containing the optical axis 41, the depression 61 has two cross-sections each having a square cross-sectional shape and has a cross-sectional shape that is symmetric with respect to the optical axis 41.

The adhesive 26 is provided in the depression 61.

The adhesive 26 substantially has a shape that fits to the shape of the depression 61. Therefore, the adhesive 26 is shaped like a ring that makes a complete round in the circumferential direction with the center being located on the optical axis 41. When viewed in a cross-sectional view taken along a plane containing the optical axis 41, the adhesive 26 has two cross-sections each having a square cross-sectional shape and has a cross-sectional shape that is symmetric with respect to the optical axis 41.

Hence, it becomes possible to apply the same quantity of viscosity fluid to the locations that are symmetric with respect to the optical axis 41. Hence, it becomes possible to generate the same magnitude of stress in the cross-sectional direction in these locations in curing the viscosity fluid. Hence, it becomes possible to restrain the deviation in position of the lens housing 25 relative to the housing 53 in the X- and Y-directions which are perpendicular to the optical axis 41.

When the adhesive 26 is provided in the depression 61, which is formed contiguously and both in the lens housing 25 in the housing 53, it is possible to increase the adhesive 26 that attaches the lens housing 25 and the housing 53 to each other in comparison with when an adhesive is provided in, for example, a depression or a notch that is formed only in either one of the lens housing 25 and the housing 53. Hence, the adhesive 26 can firmly attach the lens housing 25 and the housing 53 to each other.

When the adhesive 26 is provided in the depression 61, which is shaped like a ring, the adhesive 26 can attach the lens housing 25 and the housing 53 to each other all along the entire circumference in the circumferential direction. Hence, the adhesive 26 can firmly attach the lens housing 25 and the housing 53 to each other.

### 2.4 Depression-Defining Face

Referring to FIGS. 10 and 11, the lens housing 25 has a depression-defining face 25j.

The depression-defining face 25j of the lens housing 25 is shaped like a ring that makes a complete round in the circumferential direction with the center being located on the optical axis 41 when viewed in a plan view from the Z-direction which is parallel to the optical axis 41. The depression-defining face 25j is adjacent to the contact face 25i of the lens housing 25. The depression-defining face 25j is positioned radially outside the contact face 25i and behind the contact face 25i. The depression-defining face 25j being positioned behind the contact face 25i indicates that the depression-defining face 25j is positioned further down in the second direction D2 than is the contact face 25i. The depression-defining face 25j is oriented in a first inclined direction that is inclined radially outward from the first direction D1. Therefore, the depression-defining face 25j is positioned radially inward upon moving closer to the contact face 25i. Hence, the depression-defining face 25j imparts a taper shape and a notch shape to the rear end portion of the lens housing 25.

Referring to FIGS. 10 and 12, the housing 53 has a depression-defining face 53j and a depression-defining face 53k.

The depression-defining face 53j of the housing 53 is shaped like a ring that makes a complete round in the circumferential direction with the center being located on the optical axis 41 when viewed in a plan view from the Z-direction which is parallel to the optical axis 41. The depression-defining face 53j is a part of the front face 53d of the housing 53. The depression-defining face 53j is adjacent to the contact face 53i of the housing 53. The depression-defining face 53j is positioned radially outside the contact face 53i and behind the contact face 53i. The depression-defining face 53j being positioned behind the contact face 53i indicates that the depression-defining face 53j is positioned further down in the first direction D1 than is the contact face 53i. The depression-defining face 53j is oriented in a second inclined direction that is inclined radially outward from the second direction D2. Hence, the depression-defining face 53j is positioned radially inward upon moving closer to the contact face 53i.

The depression-defining face 53k of the housing 53 is shaped like a ring that makes a complete round in the circumferential direction with the center being located on the optical axis 41 when viewed in a plan view from the Z-direction which is parallel to the optical axis 41. The depression-defining face 53k is a part of the front face 53d of the housing 53. The depression-defining face 53k is adjacent to the depression-defining face 53j of the housing 53. The depression-defining face 53k is positioned radially outside the depression-defining face 53j and behind the contact face 53i. The depression-defining face 53k being positioned behind the contact face 53i indicates that the depression-defining face 53k is positioned further down in the first direction D1 than is the contact face 53i.

The depression-defining face 25j of the lens housing 25 and the depression-defining face 53k of the housing 53 are generally parallel to each other and provide the inner side face of the depression 61. The depression-defining face 53j of the housing 53 is generally perpendicular to the depression-defining face 25j is and the depression-defining face 53k and provides the inner bottom face of the depression 61. Hence, the depression 61 has two cross-sections each having a square cross-sectional shape when viewed in a cross-sectional view taken along a plane containing the optical axis 41. Hence, in the plane containing the optical axis 41, the entire interior of the depression 61 is visible from a direction that is parallel to the depression-defining face 25j and the depression-defining face 53k. Hence, the entire viscosity fluid applied to the interior of the depression 61 can be uniformly illuminated by ultraviolet light from this direction. Hence, the entire viscosity fluid can be uniformly cured. Hence, it is possible to reduce remaining uncured portions. Hence, the curing shrinkage can be restrained from increasing. In addition, the generation of outgas can be reduced.

The angle θ1 between the depression-defining face 25j of the lens housing 25 and the optical axis 41 and the angle θ2 between the depression-defining face 53k of the housing 53 and the optical axis 41 preferably satisfy conditions: θ1≤θ2 and θ1=approximately 45°. When the angle θ1 and the angle θ2 satisfy these conditions, the depression 61 does not narrow down toward the opening so that the optical path of ultraviolet light moves away also from the lens housing 25 and the housing 53. Hence, the viscosity fluid applied to the interior of the depression 61 can be efficiently illuminated with ultraviolet light.

The ultraviolet light projector for illuminating the viscosity fluid applied to the interior of the depression 61 with ultraviolet light has a spot diameter that is preferably specified larger than the distance from a front edge 25m of the depression-defining face 25j of the lens housing 25 to a radially outer edge 53m of the depression-defining face 53k of the housing 53. Hence, in the single plane containing the optical axis 41, the entire viscosity fluid can be illuminated with ultraviolet light without having to move the optical path of the ultraviolet light. Hence, the viscosity fluid can be efficiently illuminated with ultraviolet light.

The depression-defining face 53j of the housing 53 is oriented in an inclined direction that is inclined radially outward from the second direction D2. The depression-defining face 53k of the housing 53 is oriented in another inclined direction that is inclined radially inward from the second direction D2. Hence, the depression-defining face 53j and the depression-defining face 53k define the depression 62. The depression 62 is formed in the housing 53 and is a part of the depression 61. The depression 62 is shaped like a ring that makes a complete round in the circumferential direction with the center being located on the optical axis 41 when viewed in a plan view from the Z-direction which is parallel to the optical axis 41. Therefore, the depression 62 is built around a groove 81 that is shaped like a ring. When viewed in a cross-sectional view taken along a plane containing the optical axis 41, the depression 62 has two cross-sections each having a V-shaped cross-sectional shape.

A part of the adhesive 26 has a wedge-like shape and enters the depression 62 in the housing 53. The depression-defining face 53j and the depression-defining face 53k of the housing 53 that defines the depression 62 obstructs the part of the adhesive 26 that has entered the depression 62 from moving radially. Hence, the adhesive 26 can be restrained from moving in the shear direction in comparison with when the adhesive 26 is provided on a flat surface. Hence, the lens housing 25 and the housing 53 are more firmly attached.

The depression-defining face 25j of the lens housing 25, the depression-defining face 53j of the housing 53, and the depression-defining face 53k of the housing 53 provide a first depression-defining face, a second depression-defining face, and a third depression-defining face that define the depression 61 which is a first depression. The depression-defining face 53j of the housing 53 and the depression-defining face 53k of the housing 53 provide the second depression-defining face and the third depression-defining face that define the depression 62 which is a second depression.

### 2.5 Adjusting Optical Axis

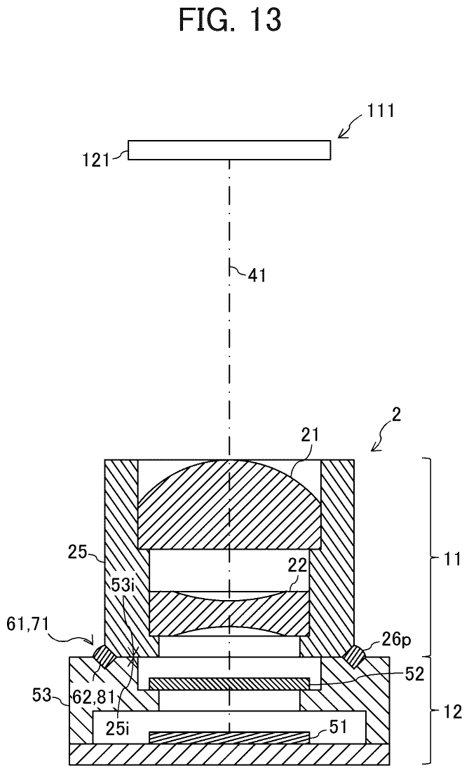

FIG. 13 is a schematic cross-sectional view of the camera module in accordance with Embodiment 2 and an optical axis adjusting unit used to adjust the optical axis of this camera module.

Referring to FIG. 13, an optical axis adjusting unit 111 used to adjust the optical axis of the camera module 2 includes an imaging object 121.

The imaging object 121 is an image-capturing chart. A mark or the like for detecting a position is drawn, for example, at the center or on the periphery of the imaging object 121. The imaging object 121 is positioned in front of the lens unit 11. Hence, the camera module 2 can capture an image of the imaging object 121 and output an image signal in accordance with the image of the imaging object 121.

When the optical axis 41 of the camera module 2 is adjusted using the optical axis adjusting unit 111, the lens housing 25 is moved relative to the housing 53 in the X- and Y-directions, which are perpendicular to the optical axis 41, while recognizing the mark for detecting a position. Hence, it is possible to match the position of the center of the lens housing 25 with the position of the center of the housing 53 in the X- and Y-directions.

To move the lens housing 25 relative to the housing 53 in the X- and Y-directions which are perpendicular to the optical axis 41, the lens housing 25 needs to be moved relative to the housing 53 in the X- and Y-directions while maintaining the contact face 25i of the lens housing 25 and the contact face 53i of the housing 53 in contact with each other. Therefore, the contact face 25i and the contact face 53i are subjected to surface treatment such as mirror polishing or coating. Hence, the contact face 25i and the contact face 53i have such a sliding property that one of the contact face 25i and the contact face 53i can be slid relative to the other one of the contact face 25i and the contact face 53i.

When the lens housing 25 is moved relative to the housing 53 in the X- and Y-directions, which are parallel to the optical axis 41 and perpendicular to the optical axis 41, the viscosity fluid 26p could flow radially outward due to the movement of the lens housing 25. However, when the depression 62 is formed in the housing 53, the viscosity fluid 26p can be restrained from flowing radially outward in comparison with when the depression 62 is not formed in the housing 53. Hence, it becomes easier to control the quantity of the viscosity fluid 26p.

### 3 Embodiment 3

The following will describe differences of Embodiment 3 to Embodiment 1. The description may be silent about the structures and features of Embodiment 3 that are the same as those of Embodiment 1.

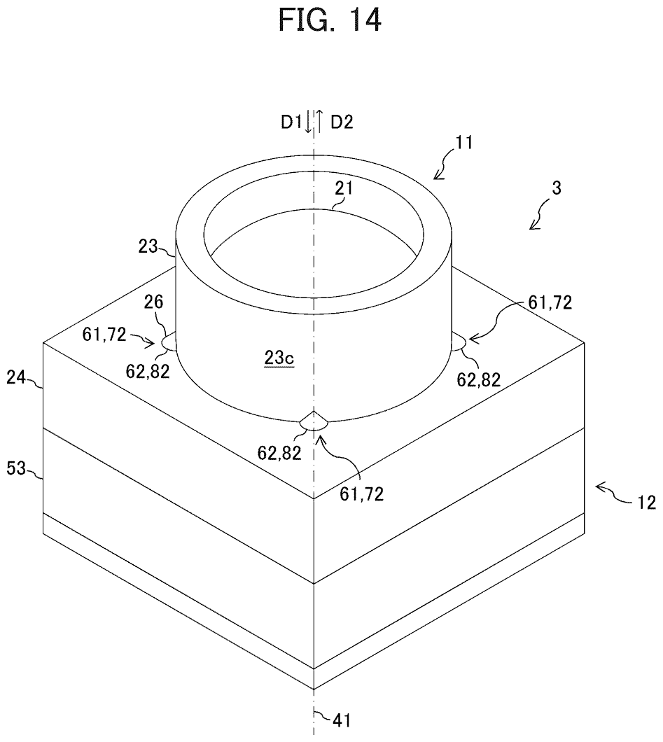

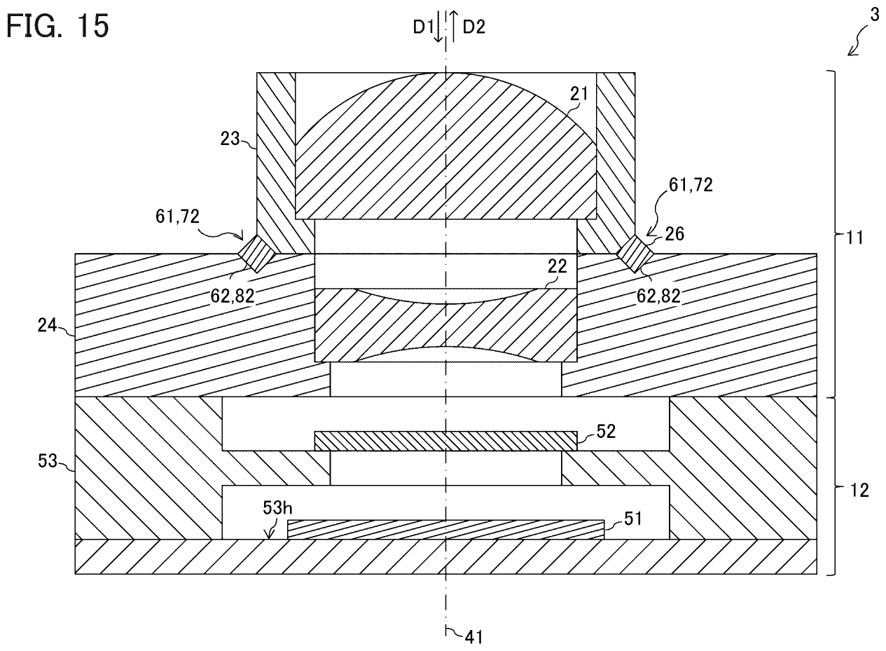

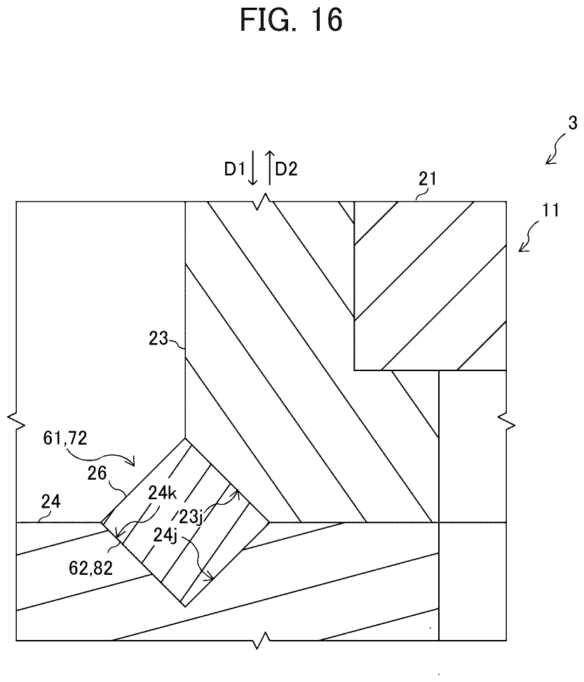

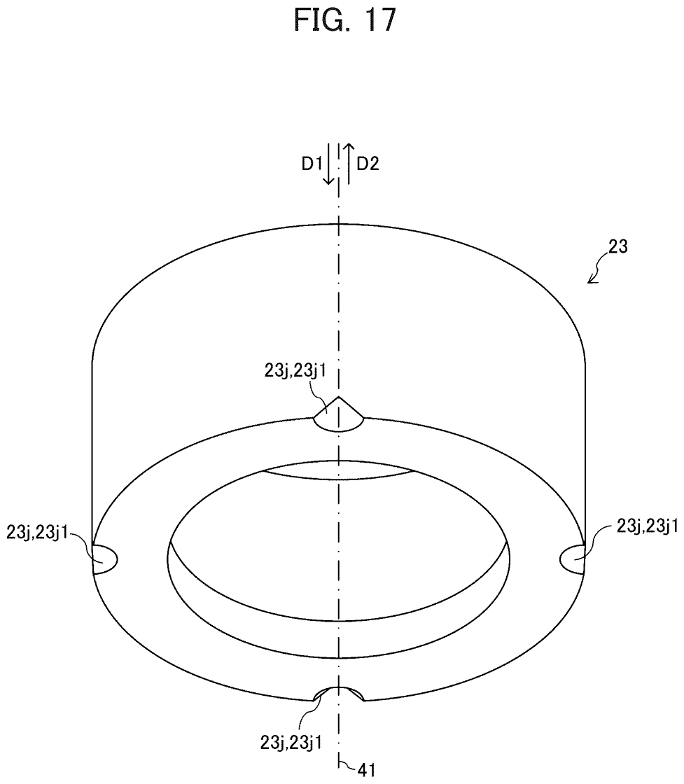

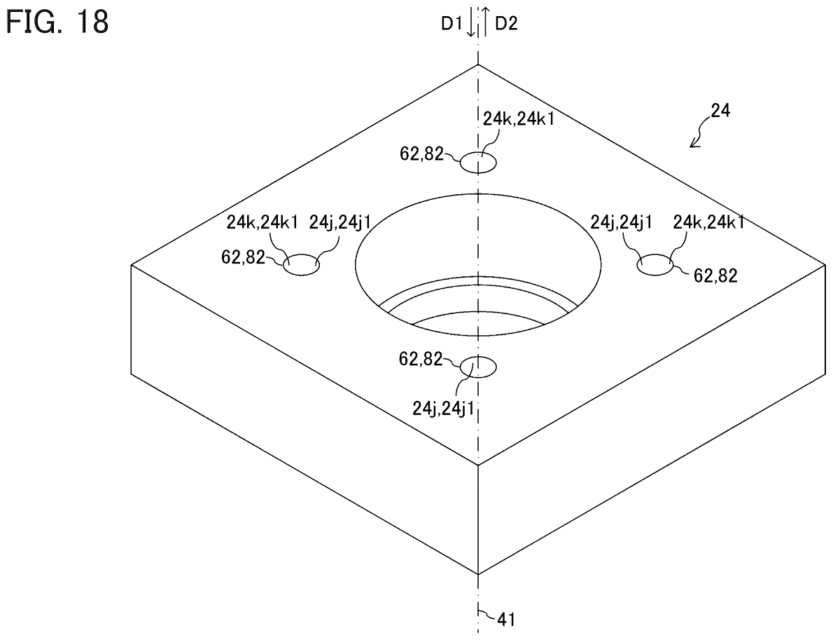

FIG. 14 is a schematic perspective view of a camera module in accordance with Embodiment 3. FIG. 15 is a schematic cross-sectional view of the camera module in accordance with Embodiment 3. FIG. 16 is a schematic cross-sectional view of a part of the camera module in accordance with Embodiment 3. FIG. 17 is a schematic perspective view of a front-side lens housing in the camera module in accordance with Embodiment 3. FIG. 18 is a schematic perspective view of a rear-side lens housing in the camera module in accordance with Embodiment 3.

In a camera module 3 in accordance with Embodiment 3, the depression 61, in which the adhesive 26 is provided, has a plurality of holes 72 as shown in FIGS. 14 to 16. The plurality of holes 72 are arranged in the circumferential direction and separated from each other when viewed in a plan view from the Z-direction which is parallel to the optical axis 41. The plurality of holes 72 are preferably arranged at equal intervals in the circumferential direction.

When the adhesive 26 is provided in the depression 61 having the plurality of holes 72 which are arranged in the circumferential direction and separated from each other, the adhesive 26 can attach the lens housing 23 and the lens housing 24 to each other at a plurality of points that are arranged in the circumferential direction and separated from each other.

When the lens housing 23 and the lens housing 24 are attached to each other at a plurality of points that are arranged in the circumferential direction and separated from each other, a plurality of ultraviolet light projectors can be provided respectively for the plurality of holes 72. In addition, the plurality of ultraviolet light projectors provided can respectively illuminate the viscosity fluid provided in the plurality of holes 72 with ultraviolet light. This configuration enables restraining the quantity of ultraviolet light with which the adhesive 26 is illuminated from becoming non-constant due to the distance from the ultraviolet light projector to the adhesive 26 becoming non-constant. Hence, it becomes possible to restrain the deviation in position of the lens housing 23 relative to the lens housing 24 in the X- and Y-directions which are perpendicular to the optical axis 41.

Referring to FIG. 17, the depression-defining face 23j of the lens housing 23 has two or more regions 23j1. The two or more regions 23j1 are arranged in the circumferential direction and separated from each other when viewed in a plan view from the Z-direction which is parallel to the optical axis 41. Referring to FIG. 18, the depression-defining face 24j of the lens housing 24 has two or more regions 24j1. The two or more regions 24j1 are arranged in the circumferential direction and separated from each other when viewed in a plan view from the Z-direction which is parallel to the optical axis 41. The two or more regions 24j1 face the two or more regions 23j1 respectively in the Z-direction which is parallel to the optical axis 41. The depression-defining face 24k of the lens housing 24 has two or more regions 24k1. The two or more regions 24kl are arranged in the circumferential direction and separated from each other when viewed in a plan view from the Z-direction which is parallel to the optical axis 41. Each hole 82 defined by one of the regions 24j1 and another one of the regions 24kl that is adjacent to that one of the regions 24j1 is shaped like a circular cone. The depression 62 has a plurality of holes 82.

### 4 Embodiment 4

The following will describe differences of Embodiment 4 to Embodiment 2. The description may be silent about the structures and features of Embodiment 4 that are the same as those of Embodiment 2.

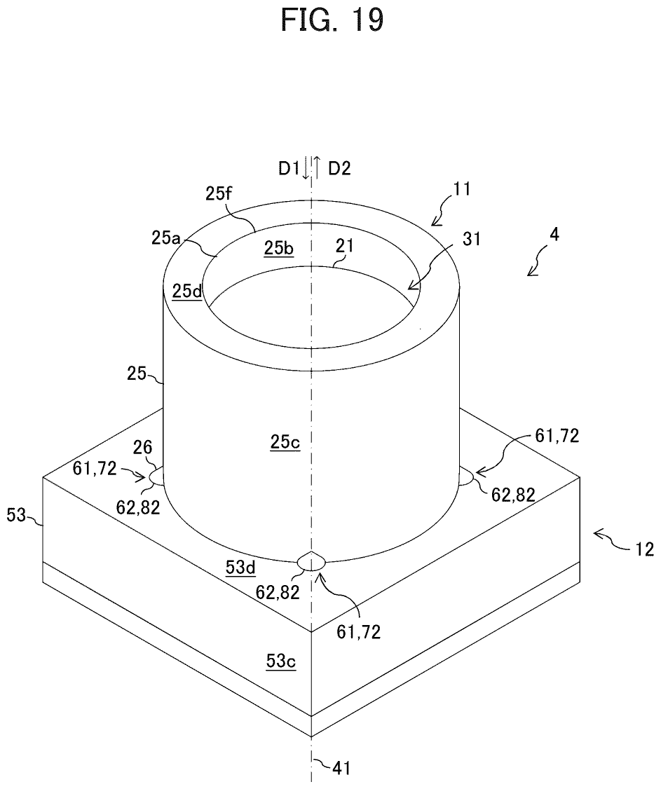

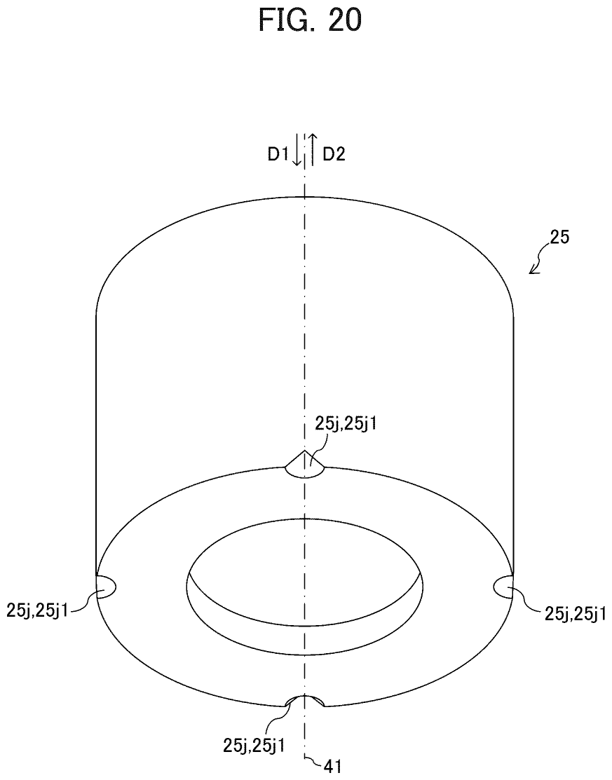

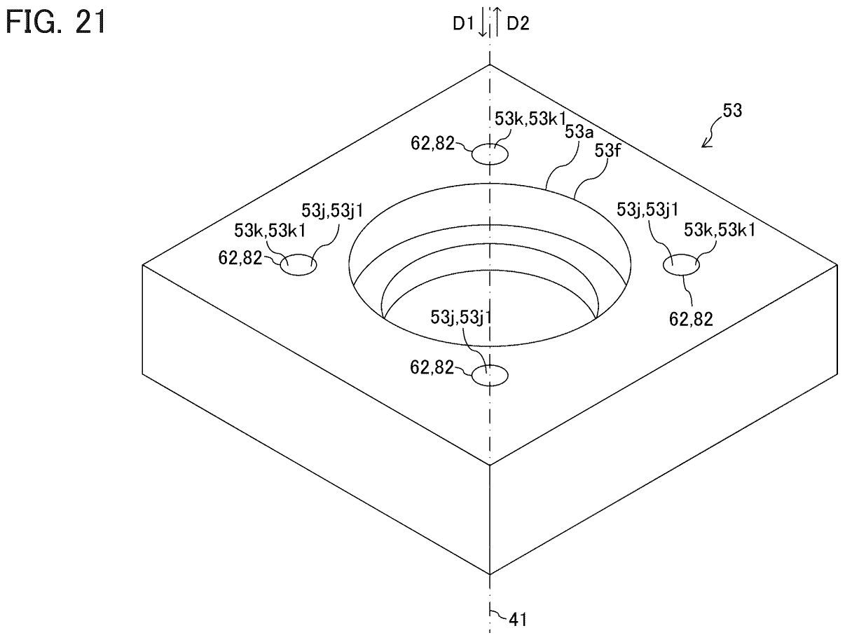

FIG. 19 is a schematic perspective view of a camera module in accordance with Embodiment 4. FIG. 20 is a schematic perspective view of a lens housing in the camera module in accordance with Embodiment 4. FIG. 21 is a schematic perspective view of a housing in the camera module in accordance with Embodiment 4.

In a camera module 4 in accordance with Embodiment 4, the depression 61, in which the adhesive 26 is provided, has a plurality of holes 72 as shown in FIGS. 19 to 21. The plurality of holes 72 are arranged in the circumferential direction and separated from each other when viewed in a plan view from the Z-direction which is parallel to the optical axis 41. The plurality of holes 72 are preferably formed at equal intervals in the circumferential direction.

When the adhesive 26 is provided in the depression 61 having the plurality of holes 72 which are arranged in the circumferential direction and separated from each other, the adhesive 26 can attach the lens housing 25 and the housing 53 at a plurality of points that are arranged in the circumferential direction and separated from each other.

When the lens housing 25 and the housing 53 are attached to each other at a plurality of points that are arranged in the circumferential direction and separated from each other, a plurality of ultraviolet light projectors can be provided respectively for the plurality of holes 72. In addition, the plurality of ultraviolet light projectors provided can respectively illuminate the viscosity fluid provided in the plurality of holes 72 with ultraviolet light. This configuration enables restraining the quantity of ultraviolet light with which the adhesive 26 is illuminated from becoming non-constant due to the distance from the ultraviolet light projector to the adhesive 26 becoming non-constant. Hence, it becomes possible to restrain the deviation in position of the housing 53 relative to the lens housing 25 in the X- and Y-directions which are perpendicular to the optical axis 41.

Referring to FIG. 20, the depression-defining face 25j of the lens housing 25 has two or more regions 25j1. The two or more regions 25j 1 are arranged in the circumferential direction and separated from each other when viewed in a plan view from the Z-direction which is parallel to the optical axis 41. Referring to FIG. 21, the depression-defining face 53j of the housing 53 has two or more regions 53j1. The two or more regions 53j1 are arranged in the circumferential direction and separated from each other when viewed in a plan view from the Z-direction which is parallel to the optical axis 41. The two or more regions 53j1 face the two or more regions 25j 1 respectively in the Z-direction which is parallel to the optical axis 41. The depression-defining face 53k of the housing 53 has two or more regions 53k1. The two or more regions 53k1 are arranged in the circumferential direction and separated from each other when viewed in a plan view from the Z-direction which is parallel to the optical axis 41. Each hole 82 defined by one of the regions 53j1 and another one of the regions 53kl that is adjacent to that one of the regions 53j1 is shaped like a circular cone. The depression 62 has a plurality of holes 82.

### 5 Embodiment 5

The following will describe differences of Embodiment 5 to Embodiment 1. The description may be silent about the structures and features of Embodiment 5 that are the same as those of Embodiment 1.

The lens housing and the image sensor housing are in many cases made of a resin. The lens housing and the image sensor housing are in many cases manufactured by, for example, cutting machining or metal die molding. However, the lens housing and the image sensor housing are sometimes manufactured using a three-dimensional printer by thermal dissolution and stacking technology in recent years.

The surface of a shaped product manufactured using a three-dimensional printer by thermal dissolution and stacking technology has projections and depressions formed reflecting the pitch of stacking. The projections and depressions formed are typically removed by polishing the surface where the projections and depressions are formed.

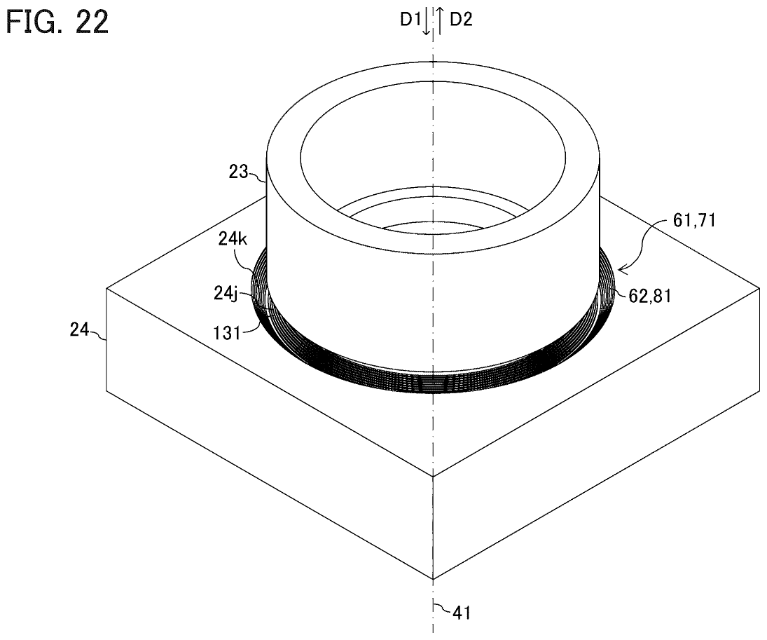

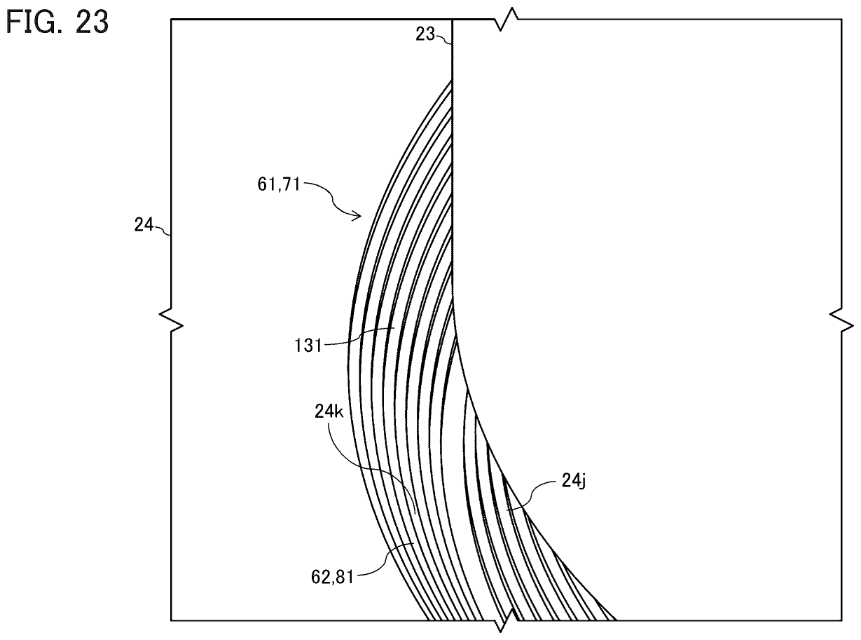

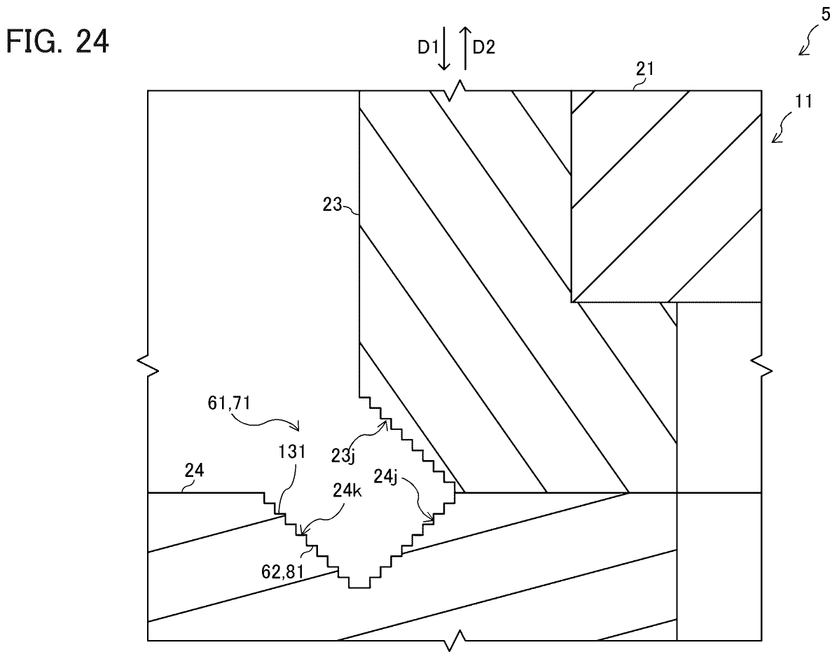

FIG. 22 is a schematic perspective view of a lens housing in the camera module in accordance with Embodiment 5. FIG. 23 is a schematic perspective view of a part of the lens housing in the camera module in accordance with Embodiment 5. FIG. 24 is a schematic cross-sectional view of a front-side lens group and a part of the lens housing in the camera module in accordance with Embodiment 5.

In a camera module 5 Embodiment 5, the lens housing 23 and the lens housing 24 are manufactured using a three-dimensional printer by thermal dissolution and stacking technology. Referring to FIGS. 22 to 24, the stacking direction is selected such that projections and depressions 131 that reflect the pitch of stacking can be formed on the depression-defining face 23j of the lens housing 23, the depression-defining face 24j of the lens housing 24, and the depression-defining face 24k of the lens housing 24. The projections and depressions 131 formed are left without being removed by polishing. Therefore, the depression-defining face 23j, the depression-defining face 24j, and the depression-defining face 24k have the projections and depressions 131. Hence, the adhesion area that is the area of the interface between the depression-defining face 23j, the depression-defining face 24j, and the depression-defining face 24k and the adhesive 26 can be increased. Hence, the adhesive 26 can firmly attach the lens housing 23 and the lens housing 24 to each other.

The projections and depressions 131 on the depression-defining face 23j, the depression-defining face 24j, and the depression-defining face 24k have differences in height that do not disrupt illumination of the viscosity fluid with ultraviolet light and have, for example, a height of approximately from 0.01 mm to 0.1 mm.

When the projections and depressions 131 are formed on the depression-defining face 23j, the depression-defining face 24j, and the depression-defining face 24k by manufacturing the lens housing 23 and the lens housing 24 using a three-dimensional printer by thermal dissolution and stacking technology, the time required to manufacture the lens housing 23 and the lens housing 24 can be reduced in comparison with when the projections and depressions 131 are formed by, for example, cutting machining.

The camera module 2 in accordance with Embodiment 2 may be so modified that the depression-defining face 25j of the lens housing 25, the depression-defining face 53j of the housing 53, and the depression-defining face 53k of the housing 53 have projections and depressions.

### 6 Embodiment 6

The following will describe differences of Embodiment 6 to Embodiment 1. The description may be silent about the structures and features of Embodiment 6 that are the same as those of Embodiment 1.

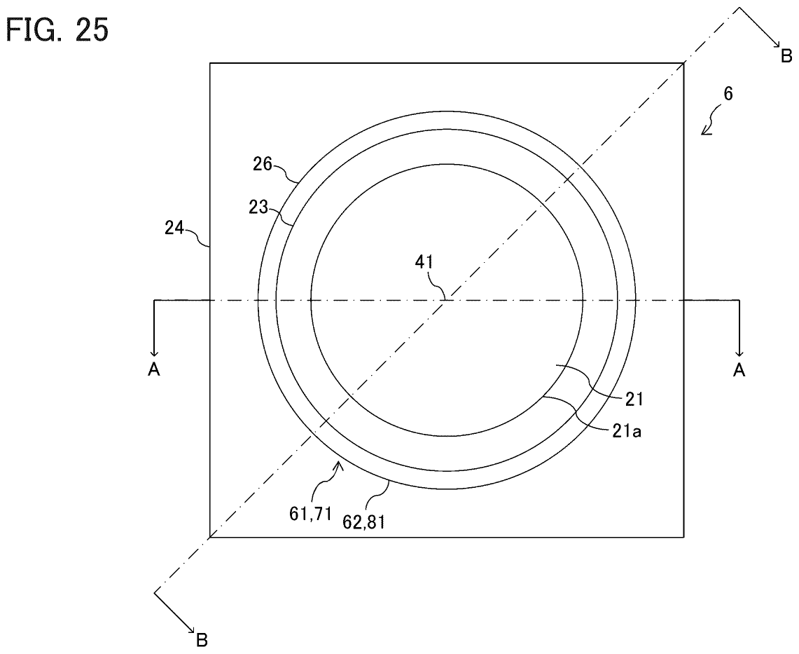

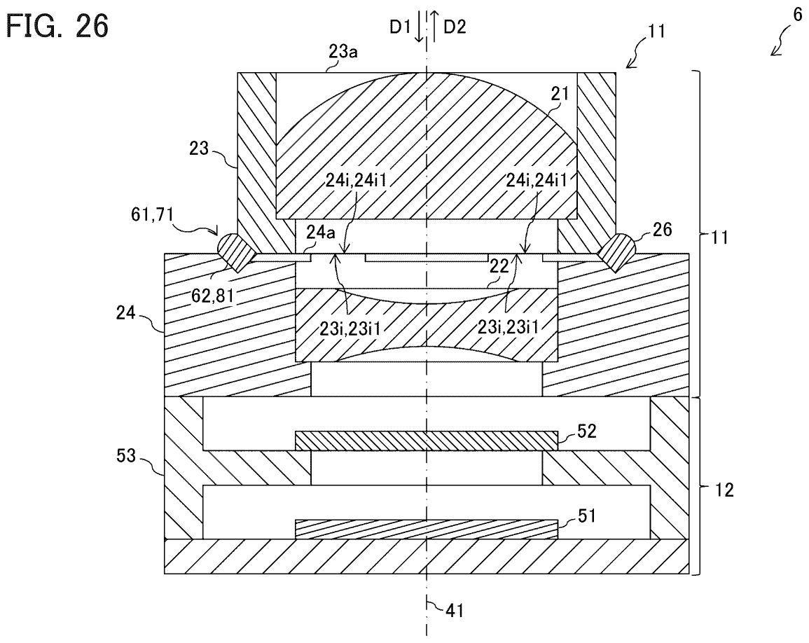

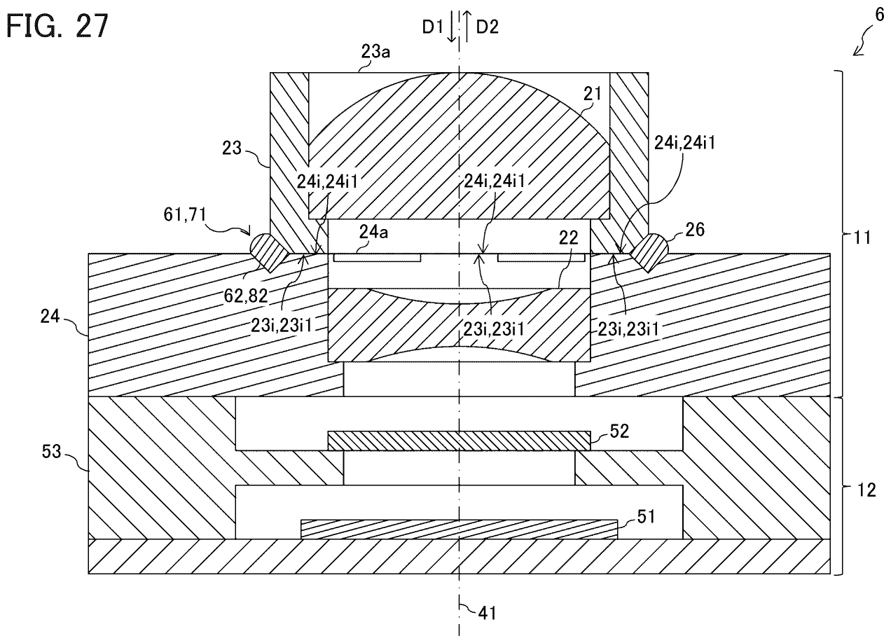

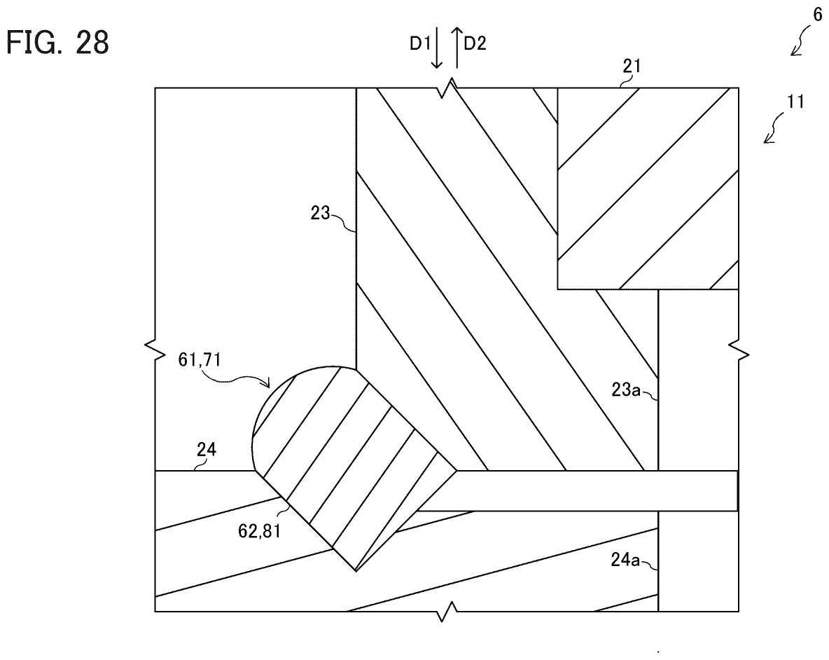

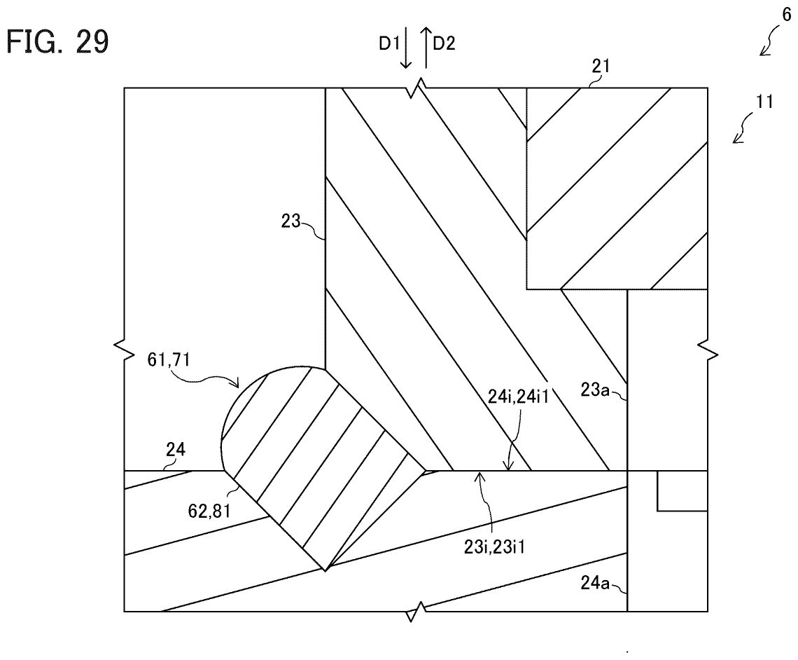

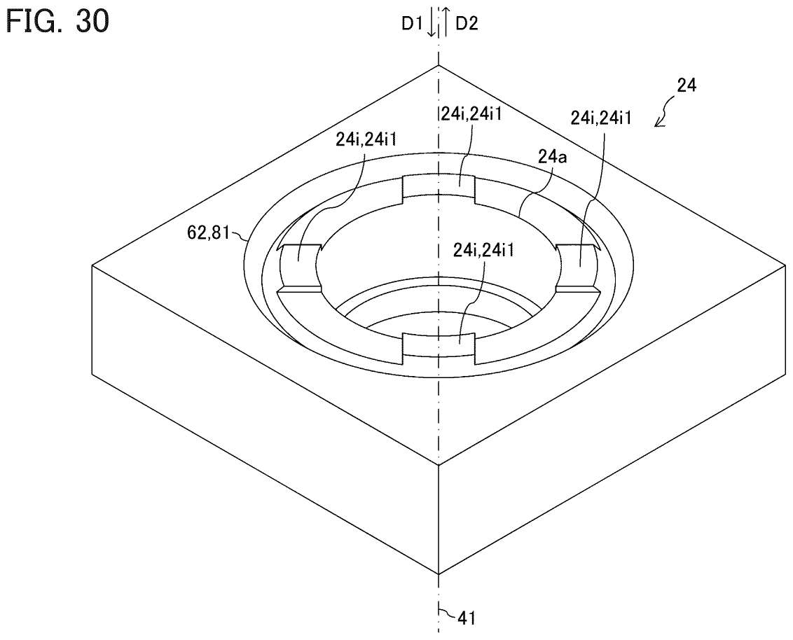

FIG. 25 is a schematic top view of a camera module in accordance with Embodiment 6. FIGS. 26 and 27 are schematic cross-sectional views of the camera module in accordance with Embodiment 6. FIGS. 28 and 29 are schematic cross-sectional views of a part of the camera module in accordance with Embodiment 6. FIG. 30 is a schematic perspective view of a rear-side lens housing in the camera module in accordance with Embodiment 6. FIGS. 26 and 28 show cross-sections taken along break line A-A shown in FIG. 25. FIGS. 27 and 29 show cross-sections taken along break line B-B shown in FIG. 26.

In a camera module 6 in accordance with Embodiment 6, the contact face 23i of the lens housing 23 has a plurality of regions 23i1 as shown in FIGS. 26 to 30. The plurality of regions 2311 are arranged in the circumferential direction and separated from each other when viewed in a plan view from the Z-direction which is parallel to the optical axis 41. In addition, the contact face 24i of the lens housing 24 has a plurality of regions 24i1. The plurality of regions 24i1 are arranged in the circumferential direction and separated from each other when viewed in a plan view from the Z-direction which is parallel to the optical axis 41. The plurality of regions 24i1 are in contact with the plurality of regions 23i1 respectively. Hence, the position of the lens housing 23 can be determined relative to the lens housing 24 in the Z-direction which is parallel to the optical axis 41, which enables eliminating the inclination of the lens housing 23 relative to the lens housing 24. The peripheral region of each region 23i1 is separated from the lens housing 24. The peripheral region of each region 24i1 is separated from the lens housing 23. Hence, the area where the contact face 23i and the contact face 24i are in contact with each other can be reduced. Hence, the friction can be reduced that is generated between the lens housing 23 and the lens housing 24 in adjusting the optical axis 41. Hence, it becomes easier to adjust the optical axis 41.

Each region 24i1 of the lens housing 24 protrudes from the peripheral region of the region 24i1. Therefore, each region 24i1 is shaped like a convex plane surface. Each region 24i1 preferably has a protrusion dimension of approximately from 0.01 mm to 0.1 mm. Hence, the gap formed between the peripheral region of each region 24i1 and the lens housing 23 has a small width of approximately from 0.01 mm to 0.1 mm. Hence, this gap can retain the viscosity fluid by surface tension. Hence, it is possible to restrain the viscosity fluid from flowing into the hole 23a of the lens housing 23 and the hole 24a of the lens housing 24 through the gap.

Either in addition to the structure where each region 24i1 of the lens housing 24 protrudes from the peripheral region or in place of the structure, a structure may be adopted where each region 23i1 of the lens housing 23 protrudes from the peripheral region.

The camera module 2 in accordance with Embodiment 2 may be so modified that the contact face 25i of the lens housing 25 has a plurality of regions that are arranged in the circumferential direction and separated from each other, that the contact face 53i of the housing 53 has a plurality of regions that are arranged in the circumferential direction and separated from each other, and that the latter plurality of regions are in contact with the former plurality of regions respectively.

### 7 Embodiment 7

The following will describe differences of Embodiment 7 to Embodiment 1. The description may be silent about the structures and features of Embodiment 7 that are the same as those of Embodiment 1.

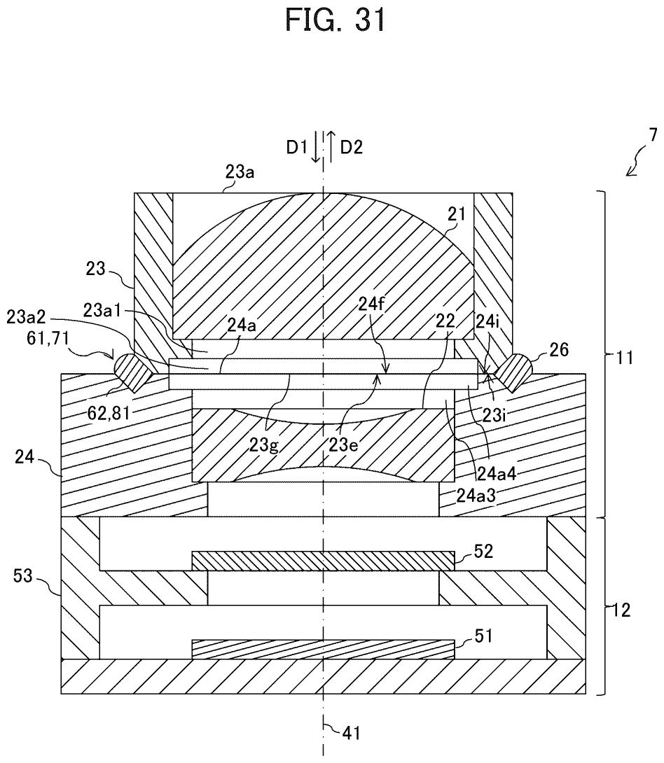

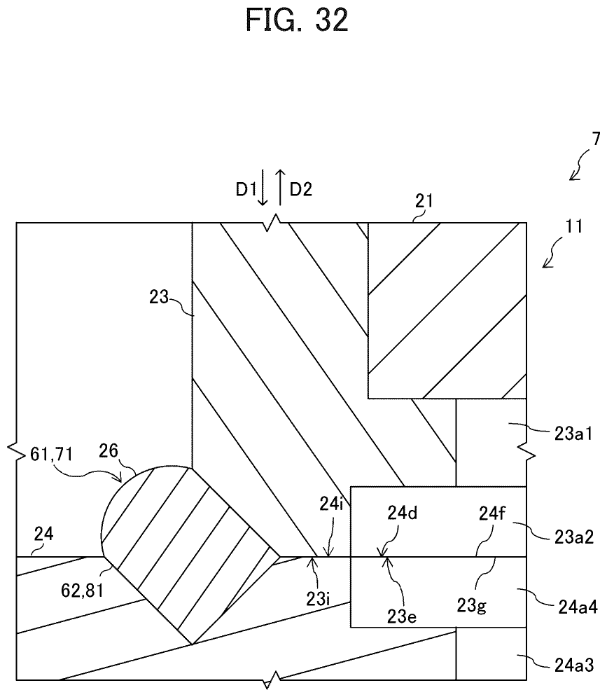

FIG. 31 is a schematic cross-sectional view of a camera module in accordance with Embodiment 7. FIG. 32 is a schematic cross-sectional view of a part of the camera module in accordance with Embodiment 7.

In a camera module 7 in accordance with Embodiment 7, as shown in FIGS. 31 and 32, the hole 23a in the lens housing 23 is a first hole that has a first portion 23a1 and a second portion 23a2, and the hole 24a in the lens housing 24 is a second hole that has a third portion 24a3 and a fourth portion 24a4.

The first portion 23a1 of the lens housing 23 is in the foreground of the lens group 21 when viewed from the rear opening 23g of the lens housing 23.

The second portion 23a2 of the lens housing 23 is in the foreground of the first portion 23a1 of the lens housing 23 when viewed from the rear opening 23g of the lens housing 23. The second portion 23a2 is spatially continuous with the first portion 23a1. The second portion 23a2 has the rear opening 23g on the rear face 23e of the lens housing 23 which provides a first surface. The second portion 23a2 has a hole shape that is larger than the hole shape of the first portion 23a1. Therefore, the rear opening 23g has an opening shape that is larger than the hole shape of the first portion 23al. Hence, the area of the contact face 23i of the lens housing 23 located along the outer circumference of the rear opening 23g can be reduced.

The second portion 23a2 of the lens housing 23 can be formed by forming a groove along the outer circumference of the opening of the hole formed in the lens housing 23.

The third portion 24a3 of the lens housing 24 is in the foreground of the lens group 22 when viewed from the front opening 24f of the lens housing 24.

The fourth portion 24a4 of the lens housing 24 is in the foreground of the third portion 24a3 of the lens housing 24 when viewed from the front opening 24f of the lens housing 24. The fourth portion 24a4 is spatially continuous with the third portion 24a3. The fourth portion 24a4 has the front opening 24f on the front face 24d of the lens housing 24 which provides a second surface. The fourth portion 24a4 has a hole shape that is larger than the hole shape of the third portion 24a3. Therefore, the front opening 24f has an opening shape that is larger than the hole shape of the third portion 24a3. Hence, the area of the contact face 24i of the lens housing 24 located along the outer circumference of the front opening 24f can be reduced.

The fourth portion 24a4 of the lens housing 24 can be formed by forming a groove along the outer circumference of the opening of the hole formed in the lens housing 24.

For these reasons, the area where the contact face 23i of the lens housing 23 and the contact face 24i of the lens housing 24 are in contact with each other can be reduced. Hence, the friction can be reduced that is generated between the lens housing 23 and the lens housing 24 in adjusting the optical axis 41. Hence, it becomes easier to adjust the optical axis 41.

The camera module 2 in accordance with Embodiment 2 may be so modified that the hole 25a of the lens housing 25 has portions that are similar to the first portion 23a1 and the second portion 23a2 and that the hole 53a of the housing 53 has portions that are similar to the third portion 24a3 and the fourth portion 24a4.

### 8 Embodiment 8

The following will describe differences of Embodiment 8 to Embodiment 7. The description may be silent about the structures and features of Embodiment 8 that are the same as those of Embodiment 7.

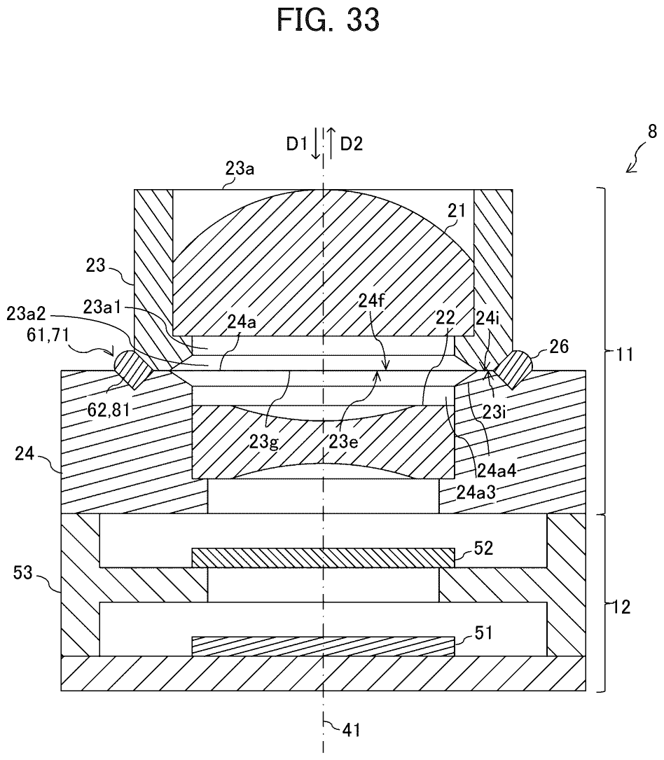

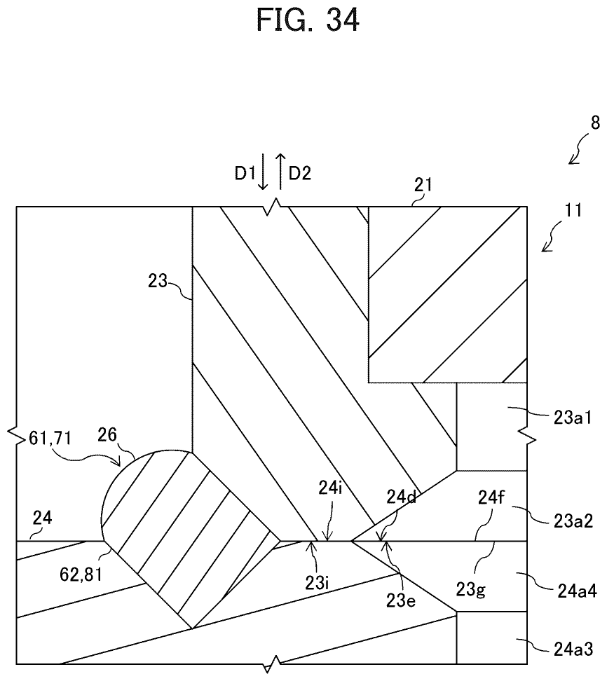

FIG. 33 is a schematic cross-sectional view of a camera module in accordance with Embodiment 8. FIG. 34 is a schematic cross-sectional view of a part of the camera module in accordance with Embodiment 8.

In a camera module 8 in accordance with Embodiment 8, as shown in FIGS. 33 and 34, the second portion 23a2 of the lens housing 23 has a hole shape that continuously grows larger from the hole shape of the first portion 23a1 of the lens housing 23 toward the rear opening 23g of the lens housing 23. Therefore, the rear opening 23g has an opening shape that is larger than the hole shape of the first portion 23al. Hence, the area of the contact face 23i of the lens housing 23 located along the outer circumference of the rear opening 23g can be reduced.

The second portion 23a2 of the lens housing 23 can be formed by C chamfering along the outer circumference of the opening of the hole formed in the lens housing 23.

The fourth portion 24a4 of the lens housing 24 has a hole shape that continuously grows larger from the hole shape of the third portion 24a3 of the lens housing 24 toward the front opening 24f of the lens housing 24. Therefore, the front opening 24f of the lens housing 24 has an opening shape that is larger than the hole shape of the third portion 24a3 of the lens housing 24. Hence, the area of the contact face 24i located along the outer circumference of the front opening 24f of the lens housing 24 can be reduced.

The fourth portion 24a4 of the lens housing 24 can be formed by C chamfering along the outer circumference of the opening of the hole formed in the lens housing 24.

For these reasons, the area where the contact face 23i of the lens housing 23 and the contact face 24i of the lens housing 24 are in contact with each other can be reduced. Hence, the friction can be reduced that is generated between the lens housing 23 and the lens housing 24 in adjusting the optical axis 41. Hence, it becomes easier to adjust the optical axis 41 of the lens unit 11.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An optical device comprising:
a first lens group having an optical axis;
a held body being either a second lens group or an image sensor;
a first housing holding the first lens group and having: a first contact face that is perpendicular to the optical axis; and a first depression-defining face that is positioned adjacent to, and behind, the first contact face and that is positioned radially inward upon moving closer to the first contact face;
a second housing holding the held body and having: a second contact face that is in contact with the first contact face; and a second depression-defining face that is positioned adjacent to, and behind, the second contact face and that, in combination with the first depression-defining face, defines a depression; and
an adhesive provided in the depression and attaching the second housing to the first housing.

2. The optical device according to claim 1, wherein
the first contact face is oriented in a first direction,
the second contact face is oriented in a second direction opposite to the first direction,
the first depression-defining face is oriented in a first inclined direction that is inclined radially outward from the first direction, and
the second depression-defining face is oriented in a second inclined direction that is inclined radially outward from the second direction.

3. The optical device according to claim 1, wherein
the depression is a first depression,
the second depression-defining face is oriented in an inclined direction that is inclined radially outward from a direction in which the second contact face is oriented,
the second housing has a third depression-defining face that is positioned radially outward the second depression-defining face, that is positioned behind the second contact face, that is oriented in another inclined direction that is inclined radially inward from the second direction, and that defines the first depression in combination with the first depression-defining face and the second depression-defining face, and
the second depression-defining face and the third depression-defining face define a second depression that is formed in the second housing and that is a part of the first depression.

4. The optical device according to claim 1, wherein the first contact face and the second contact face are shaped like a ring that makes a complete round in the circumferential direction.

5. The optical device according to claim 1, wherein
the first contact face has a first plurality of regions that are arranged in the circumferential direction and separated from each other, and
the second contact face has a second plurality of regions that are arranged in the circumferential direction and separated from each other.

6. The optical device according to claim 1, wherein the first contact face and the second contact face have such a sliding property that one of the first contact face and the second contact face is slid relative to another one of the first contact face and the second contact face.

7. The optical device according to claim 1, wherein the first depression-defining face and the second depression-defining face are shaped like a ring that makes a complete round in the circumferential direction.

8. The optical device according to claim 1, wherein
the first depression-defining face has first two or more regions that are arranged in the circumferential direction and separated from each other, and
the second depression-defining face has second two or more regions that are arranged in the circumferential direction and separated from each other.

9. The optical device according to claim 1, wherein the first depression-defining face and the second depression-defining face have projections and depressions.

10. The optical device according to claim 1, wherein
the first housing has a first surface,
a first hole is formed in the first housing, the first hole having: a first portion; and a second portion that is on the first surface, that has a first opening having an opening shape larger than a hole shape of the first portion, and that is spatially continuous with the first portion,
the second housing has a second surface,
a second hole is formed in the second housing, the second hole having: a third portion; and a fourth portion that is on the second surface, that has a second opening having an opening shape larger than a hole shape of the third portion, and that is spatially continuous with the third portion,
the first contact face is provided along an outer circumference of the first opening, and
the second contact face is provided along an outer circumference of the second opening.

11. The optical device according to claim 1, wherein the adhesive has a cross-section having a square cross-sectional shape when viewed in a cross-sectional view taken along a plane containing the optical axis.

12. The optical device according to claim 1, wherein the adhesive has a symmetric cross-sectional shape with respect to the optical axis when viewed in a cross-sectional view taken along a plane containing the optical axis.

13. The optical device according to claim 1, wherein
the held body is the second lens group, and
the optical device is a lens unit.

14. The optical device according to claim 1, wherein
the held body is the image sensor, and
the optical device is a camera module.
